(19) United States
(12) Patent Application Publication
(10) Pub. No.: US 2006/0187491 A1
(43) Pub. Date: Aug. 24, 2006

(54) Printing device, printing program, printing method, image processing device, image processing program, image processing method, and recoding medium with the programs recorded thereon

(75) Inventor: Hiroaki Sakai, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/358,878

(22) Filed: Feb. 21, 2006

(30) Foreign Application Priority Data
Feb. 22, 2005 (JP) 2005-045135
Oct. 24, 2005 (JP) 2005-308404

(51) Int. Cl. G06F 15/00

(52) U.S. Cl. 358/3.27; 358/1.9

(57) ABSTRACT

A printing device including: a unit partitioning M image data (M≧3) into a plurality of partition regions; a unit that detects an edge in the M image data; a unit enhancing the detected edge; a unit determining whether each of the partition regions includes an edge; a unit determining whether the non-edge including partition region is a middle tone region; a first unit generating N image data by converting, into N (M>N≧2) with a first process, the image data of the middle tone partition; a second unit generating N image data by converting, into N with a second process, the image data of the edge-including partition region, or the image data of the non-middle tone partition region; a unit generating printing data with dot setting corresponding to pixels of the N image data generated by the first and second units; and a printing unit performing printing.

### RELATED APPLICATIONS

This application claims priority to Japanese Patent Application Nos. 2005-045135 filed Feb. 22, 2005 and 2005-308404 filed Oct. 24, 2005 which are hereby expressly incorporated by reference herein in their entirety.

### BACKGROUND

1. Technical Field

The present invention relates to printing devices for use with facsimile machines, copying machines, printers of OA equipment, and others. More specifically, the present invention relates to a printing device suitable for printing with a so-called ink jet technology, and capable of text and image rendering onto a printing paper (printing material) through discharge of liquid ink particles of various colors, a printing program and method for such a printing device, an image processing device, program, and method, and a recording medium with the programs recorded thereon.

2. Related Art

With the reason of relatively inexpensive price and the ease of achieving high-quality color printing, a printer utilizing the ink jet technology (hereinafter, “ink jet printer”) has become widely popular not only for office use but also for personal use with the spread of personal computers, digital cameras, and others.

Such an ink jet printer generally performs text and image rendering on a printing medium (paper) using a moving element in a predetermined manner so that any desired printing is achieved. More in detail, the moving element referred to as carriage includes an ink cartridge and a printing head as a piece, reciprocating on the printing paper in the direction lateral to the paper feeding direction, and discharging (ejecting) liquid ink droplets in dots from the nozzles provided to the printing head. If the carriage is provided with ink cartridges of four colors, i.e., black, yellow, magenta, and cyan, and their each corresponding printing head, full-color printing becomes easily possible in addition to monochrome printing by color mixture. Better still, the ink cartridges of six, seven, or eight colors additionally with light cyan, light magenta, and others are also in practical use.

There is a problem with such an ink jet printer of a type performing printing with the printing head reciprocating on the carriage laterally in the paper feeding direction, i.e., the width direction of the printing paper. That is, to derive a clearly-printed page, the printing head is required to undergo frequent reciprocating movements, e.g. several tens to a hundred or more. This results in a drawback of a longer printing time compared with other types of printing device such as electrophotographic laser printers or others, e.g., copying machines.

On the other hand, with an ink jet printer of a type using no carriage but a long printing head having the same width (or longer) as that of the printing paper, there is no need to move the printing head in the width direction of the printing paper. This accordingly allows printing with a single pass, favorably leading to high-speed printing as can be with the laser printers. What is better, this eliminates the need for a carriage with a printing head, and a drive system for moving the carriage, thereby advantageously reducing the size and weight of the cabinet of the printer, and the noise to a considerable degree. Note here that the ink jet printer of the former type is generally referred to as “multi-pass printer”, and the ink jet printer of the latter type as “line-head printer”.

The issue with such an ink jet printer is the manufacturing deviation observed in the printing head that serves an essential role for the ink jet printer. The manufacturing deviation results from the configuration of the printing head, carrying very small nozzles of about 10 to 70 μm in diameter in series at regular intervals, or in a plurality of lines in the printing direction. In such a configuration, the nozzle may be partially misaligned so that the ink discharge direction is incorrectly angled, or the nozzles may not be correctly disposed as they are expected to be so that the nozzles resultantly fail in forming dots at their ideal positions, i.e., causes so-called ink deflection.

As a result, an image part printed by such a faulty nozzle suffers a printing failure, i.e., so-called banding (streaking) problem, resultantly reducing the printing quality considerably. More in detail, with ink deflection occurring, the dot-to-dot distance between dots formed by any adjacent nozzles becomes not uniform. When such a dot-to-dot distance is longer than usual, the corresponding part suffers from white streaks when the printing paper is white in color. When the dot-to-dot distance is shorter than usual, the corresponding part suffers from dark streaks.

Such a banding problem is often observed in “line head printers” in which a printing head is fixed, i.e., printing with a single pass, and the number of nozzles is considerably larger than the above-described “multi-pass printers”. This is because the multi-pass printers are adopting the technology of making the white streaks less noticeable utilizing the frequent reciprocating movements of the printing head.

For the purpose of preventing printing failures caused by the banding problem, research and development has been actively conducted from the hardware perspective, e.g., improving the manufacturing technology of the printing head, or improving the design thereof. However, from the perspective of manufacturing cost, printing quality, technology, or others, it is found difficult to provide a printing head perfectly free from the banding problem.

In consideration of the above, the currently-available technology for correcting the banding problem is adopting a so-called software technique such as printing control as below in addition to such improvements from the hardware perspective as described above.

As an example for such a technology, Patent Document 1 (JP-A-6-340094) describes “ink jet recording device and method”, in which the dot size is made uniform in the nozzle disposition direction of a printing head but is made to irregularly change in the driving direction of the printing head, i.e., vertical direction with respect to the nozzle disposition direction. Through such dot size change, Patent Document 1 aims to correct the “banding problem, i.e., reducing white streaks extending in the vertical direction with respect to the nozzle disposition direction.

The problem with the technology of Patent Document 1 is that density variation occurs at printing with any one specific density, i.e., any region of uniform density is partially changed in density, thereby often causing the printing quality to be reduced. Another problem is that the dot size change is performed at irregular intervals. In this sense, if small dots appear sequentially, it is difficult to reduce white streaks appearing in its vicinity.

### SUMMARY

An advantage of some aspects of the invention is to provide a printing device, program, and method, an image processing device, program, and method, and a recording medium with the programs recorded thereon, all of which are newly developed, and capable of eliminating or making less noticeable a banding problem as a result of ink deflection.

First Aspect

A first aspect of the invention is directed to a printing device that includes: a block partition unit that partitions image data of a value M (M≧3) into a plurality of partition regions; an edge detection unit that detects an edge in the M-value image data; an edge enhancement unit that enhances the edge detected by the edge detection unit; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; and a printing unit that performs printing based on the printing data generated by the printing data generation unit.

With such a configuration, a banding problem as a result of ink deflection is favorably reduced so that white or dark streaks can be eliminated or made less noticeable. The printing result can be thus high in quality with efficiency. Such a configuration also enables processing appropriate to each of the partition regions so that the printing process can be performed with efficiency.

That is, by partitioning multi-value (M-value (M≧3)) image data into a plurality of partition regions, and by enhancing edges detected in the M-value (M≧3) image data, a banding problem observed in the vicinity of the edges is made less noticeable. Edge detection is made by filtering images using a Laplacian filter or others, and edge enhancement is performed by varying the edge density from side to side for value adjustment of pixels located at the edges.

When any of the partition regions is determined as including no edge, another determination is made whether the partition region is a middle tone region or not. When the determination is made as Yes, the middle tone region is subjected to a first N-value process to be reduced with a banding problem.

When the determination is made as No, on the other hand, the partition region is subjected to a second N-value process, which is a normal N-value process giving no specific consideration to the banding problem.

That is, the banding problem described above is not that noticeable in regions where the density is considerably high or considerably low, but is quite conspicuous in middle tone regions of intermediate density (brightness).

In consideration thereof, in the first aspect, any partition region determined as being a middle tone region is subjected to the first N-value process, which will be described later, for reducing the banding problem. For any partition region determined as not being a middle tone region, applied is the second N-value process being a normal N-value process. The N-value data derived through each different N-value processes as such configures printing data, and by using the resulting printing data for printing, an attempt is made to prevent the banding problem with efficiency.

Herein, the expression of “first N-value process” means a process of adjusting a value N, e.g., when small dots appear in succession in a middle tone region, one of two dots is increased in size. The first N-value process will be described later with a specific example. The expression of “second N-value process” means a normal N-value process utilizing general error diffusion or dithering. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The expression of “banding problem” means not only white streaks as a result of ink deflection but also a printing failure of white and dark streaks observed together in the printing result. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The expression of “ink deflection” means a phenomenon in which, unlike the mere ink discharge failures occurring to some of the nozzles as described above, the nozzles have no problem for ink discharge but are partially misaligned so that the ink discharge direction is incorrectly angled, thereby failing in forming dots at their ideal positions. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The expression of “white streaks” denotes the parts (regions) of a printing medium whose base appears streaky in color. This is due to the ink deflection, resultantly causing the dot-to-dot distance between any adjacent dots to be often wider than a predetermined distance. The expression of “dark streaks” denotes the parts (regions) of a printing medium whose base is not visible in color or looks relatively darker due to also the ink deflection, resultantly causing the dot-to-dot distance between any adjacent dots to be often narrower than the predetermined distance. The expression of “dark streaks” also denotes the parts (regions) of a printing medium that look streaky dark in color, caused by dots not formed at their ideal positions by being partially overlaid on dots formed at their normal positions. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The expression of “value M (M≧3)” means a multi-level pixel value related to brightness or density, represented as 8 bits 256 gray levels, for example. The expression of “value N (M>N≧2)” means a process of classifying, into N, pixel values of M-value (multi-value) data based on a specific threshold value. The expression of “dot size” denotes a concept of not only the size (area) of dots but also of forming no dot, for example. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The reason of setting the value of N to “N≧2” is that, for generation of printing data, there needs to at least define the value as being 2 or more, i.e., dots are to be formed or not. The reason of a setting as “M>N” is to confine the multi-level pixel value of 8 bit, 256 gray levels (M-value), for example, to a range of gray levels fewer than that of the original pixel values, e.g., about 4 to 8 gray levels. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

The expression of “middle tone region” denotes a range in which the input or output brightness is 50 to 100, or 100 to 150, for example. In a broad sense, a range not including 0 and 100 denotes “middle tone region”, and the expression of “edge” means a boundary between any regions similar in characteristics, e.g., density value, color, or pattern. This is applicable to aspects of “printing device”, “printing program”, “printing method”, “image processing device”, “image processing program”, “image processing method”, and “recording medium with the programs recorded thereon”, and descriptions in the “description of exemplary embodiments”, and others.

Second Aspect

According to a printing device of a second aspect, in the first aspect, the edge enhancement unit reduces a pixel value of any of the pixels located at a portion of the edge.

This accordingly reduces the size of a dot for the pixel, and the difference in size is thus increased between the resulting size-reduced dot and a dot for the next pixel with an edge therebetween so that the edge portion can be enhanced with efficiency.

Third Aspect

According to a printing device of a third aspect, in the first aspect, the edge enhancement unit increases a pixel value of any of the pixels located at a portion of the edge.

This accordingly increases the size of a dot for the pixel, and the difference in size is thus increased between the resulting size-increased dot and a dot for the next pixel with an edge therebetween so that the edge portion can be enhanced with efficiency.

Fourth Aspect

According to a printing device of a fourth aspect, in the first aspect, any one of or two or more of the edge enhancement unit, the edge determination unit, the middle tone region determination unit, and the printing data generation unit are plurally provided.

Such a configuration enables to make the component units in the printing device of the first aspect execute their own processes simultaneously or separately, thereby favorably leading to the efficient printing process.

Fifth Aspect

A fifth aspect of the invention is directed to a printing device that includes: a block partition unit that partitions image data of a value M (M≧3) into a plurality of partition regions; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; a dot size change unit that changes a size of any of the dots located at a portion of the edge in the printing data that is generated by the printing data generation unit and is corresponding to the N-value image data generated by the second N-value data generation unit, and enhances the edge; and a printing unit that performs printing based on the printing data in which a dot size change is performed by the dot size change unit, and the printing data generated by the printing data generation unit.

With such a configuration, similarly to the first aspect, a banding problem as a result of ink deflection is reduced so that white or dark streaks can be eliminated or made less noticeable. The printing result can be thus high in quality with efficiency. Such a configuration also enables processing appropriate to each of the partition regions so that the printing process can be performed with efficiency.

There is a difference between the fifth aspect and the first aspect in view of configuration. Although the difference will be described in detail later with a specific example, in the first aspect, the image data is enhanced at edge portions in advance by the edge enhancement unit with an aim of preventing a banding problem from occurring to the edge portions. In the fifth aspect, on the other hand, the image data is enhanced at edge portions by the dot size change unit changing the size of dots in the edge portions after the N-value process. The fifth aspect also excellently prevents a banding problem with efficiency similarly to the first aspect.

Sixth Aspect

According to a printing device of a sixth aspect, in the second aspect, the dot size change unit reduces the size of any of the dots located at the portion of the edge.

This accordingly reduces the size of a dot for the pixel, and the difference in size is thus increased between the resulting size-reduced dot and a dot for the next pixel with an edge therebetween so that the edge portion can be enhanced with efficiency.

Seventh Aspect

According to a printing device of a seventh aspect, in the second aspect, the dot size change unit increases the size of any of the dots located at the portion of the edge.

This accordingly increases the size of a dot for the pixel, and the difference in size is thus increased between the resulting size-increased dot and a dot for the next pixel with an edge therebetween so that the edge portion can be enhanced with efficiency.

Eighth Aspect

According to a printing device of an eighth aspect, in the second aspect, any one of or two or more of the edge determination unit, the middle tone region determination unit, the printing data generation unit, and the dot size change unit are plurally provided.

Such a configuration enables to make the component units in the printing device of the second aspect execute their own processes simultaneously or separately, thereby favorably leading to the efficient printing process.

Ninth Aspect

A ninth aspect of the invention is directed to a printing device that includes: a block partition unit that partitions image data of a value M (M≧3) into a plurality of partition regions; an edge detection unit that detects an edge partially in any of the partition regions as a result of partition by the block partition unit; an edge enhancement unit that enhances the edge detected by the edge detection unit; a first edge determination unit that determines whether the partition region edge-enhanced by the edge enhancement unit includes an edge or not; a first middle tone region determination unit that determines whether the partition region determined as not including the edge by the first edge determination unit as being a middle tone region or not; a first N-value data generation unit that generates N-value image data by converting, into a value N (M>N≧2) by going through a first N-value process, the image data of the partition region determined as being the middle tone region by the first middle tone region determination unit; a second N-value data generation unit that generates the N-value image data by converting, into the value N by going through a second N-value process, the image data of the partition region determined as including the edge by the first edge determination unit, or the image data of the partition region determined as not being the middle tone region by the first middle tone region determination unit; and a first printing data generation unit that generates printing data in which a dot setting is correspondingly made to pixels of the N-value image data generated by the first N-value data generation unit, and pixels of the N-value image data generated by the second N-value data generation unit, and includes a second edge determination unit that determines whether the partition regions as a result of partition by the block partition unit except for the partition regions through with detection by the edge detection unit include the edge or not; a second middle tone region determination unit that determines whether the partition region determined as not including the edge by the second edge determination unit is the middle tone region or not; a third N-value data generation unit that generates the N-value image data by converting, into the value N by going through the first N-value process, the image data of the partition region determined as being the middle tone region by the second middle tone region determination unit; a fourth N-value data generation unit that generates the N-value-image data by converting, into the value N by going through the second N-value process, the image data of the partition region determined as including the edge by the second edge determination unit, or the image data of the partition region determined as not being the middle tone region by the second middle tone region determination unit; a second printing data generation unit that generates printing data in which a dot setting is correspondingly made to pixels in the N-value image data generated by the third N-value data generation unit, and pixels in the N-value image data generated by the fourth N-value data generation unit; a dot size change unit that changes a size of any of the dots located at a portion of the edge in the printing data that is generated by the second printing data generation unit and is corresponding to the N-value image data generated by the fourth N-value data generation unit, and enhances the edge; a printing data synthesis unit that synthesizes together the printing data in which a dot size change is performed by the dot size change unit, the printing data generated by the second printing data generation unit, and the printing data generated by the first printing data generation unit; and a printing unit that performs printing based on the printing data as a result of data synthesis by the printing data synthesis unit.

That is, the printing device of the ninth aspect applies the processes of the first aspect not to all of the partition regions as a result of partition by the block partition unit but only to a part thereof. To the remaining partition regions, the processes of the second aspect are applied.

Such a manner enables simultaneous processing on a block basis in addition to the effects achieved by the first and second aspects so that the printing process can be increased in efficiency in its entirety. What is more, the periodicity becomes less apparent to a further degree than with the first or second aspects so that the printing result can be high in quality.

Tenth Aspect

A tenth aspect of the invention is directed to a printing program embodied on a computer readable medium for use with a computer operable as: a block partition unit that partitions image data of a value M (M≧3) into a plurality of partition regions; an edge detection unit that detects an edge in the M-value image data; an edge enhancement unit that enhances the edge detected by the edge detection unit; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; and a printing unit that performs printing based on the printing data generated by the printing data generation unit.

With such a configuration, similarly to the first aspect, a banding problem as a result of ink deflection is favorably reduced so that white or dark streaks can be eliminated or made less noticeable. The printing result can be thus high in quality with efficiency. Such a configuration also enables processing appropriate to each of the partition regions so that the printing process can be performed with efficiency.

Printing devices on the current market such as ink jet printers are each provided with a computer system, which is configured to include a central processing unit (CPU), a storage device (Random Access Memory (RAM), Read Only Memory (ROM)), an input/output device, or others. Using such a computer system, the component units can be implemented by software. The printing program thus can implement the component units more economically and with more ease than a case with hardware that is specifically built for the purpose. Moreover, through partial rewriting of the program, it leads to easy version up by function modification or improvement, for example.

Eleventh Aspect

According to a printing program of an eleventh aspect, in the tenth aspect, the edge enhancement unit reduces a pixel value of any of the pixels located at a portion of the edge.

Similarly to the second aspect, the difference in size is thus increased between the resulting size-reduced dot and a dot for the next pixel with an edge therebetween so that the edge portion can be enhanced with efficiency.

Similarly also to the tenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Twelfth Aspect

According to a printing program of a twelfth aspect, in the tenth aspect, the edge enhancement unit increases a pixel value of any of the pixels located at a portion of the edge.

Similarly to the third aspect, the difference in size is thus increased between the resulting size-increased dot and a dot for the next pixel with an edge therebetween so that the edge portion can be enhanced with efficiency.

Similarly also to the tenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Thirteenth Aspect

According to a printing program of a thirteenth aspect, in the tenth aspect, any one of or two or more of the edge enhancement unit, the edge determination unit, the middle tone region determination unit, and the printing data generation unit are plurally provided.

Similarly to the fourth aspect, such a configuration enables to make the component units in the printing program of the tenth aspect execute their own processes simultaneously or separately, thereby favorably leading to the efficient printing process.

Fourteenth Aspect

A printing program of a fourteenth aspect is directed to a printing program embodied on a computer readable medium for use with a computer operable as: a block partition unit that partitions image data of a value M (M≧3) into a plurality of partition regions; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; a dot size change unit that changes a size of any of the dots located at a portion of the edge in the printing data that is generated by the printing data generation unit and is corresponding to the N-value image data generated by the second N-value data generation unit, and enhances the edge; and a printing unit that performs printing based on the printing data in which a dot size change is performed by the dot size change unit, and the printing data generated by the printing data generation unit.

With such a configuration, similarly to the fifth aspect, a banding problem as a result of ink deflection is reduced so that white or dark streaks can be eliminated or made less noticeable. The printing result can be thus high in quality with efficiency. Such a configuration also enables processing appropriate to each of the partition regions so that the printing process can be performed with efficiency.

Similarly also to the tenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Fifteenth Aspect

According to a printing program of a fifteenth aspect, in the fourteenth aspect, the dot size change unit reduces the size of any of the dots located at the portion of the edge.

Similarly to the sixth aspect, the difference in size is thus increased between the resulting size-reduced dot and a dot for the next pixel with an edge therebetween so that the edge portion can be enhanced with efficiency.

Similarly also to the fourteenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Sixteenth Aspect

According to a printing program of a sixteenth aspect, in the fourteenth aspect, the dot size change unit increases the size of any of the dots located at the portion of the edge.

Similarly to the seventh aspect, the difference in size is thus increased between the resulting size-increased dot and a dot for the next pixel with an edge therebetween so that the edge portion can be enhanced with efficiency.

Similarly also to the fourteenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Seventeenth Aspect

According to a printing program of a seventeenth aspect, in the fourteenth aspect, any one of or two or more of the edge determination unit the middle tone region determination unit, the printing data generation unit, and the dot size change unit are plurally provided.

Similarly to the eighth aspect, such a configuration enables to make the component units in the printing program of the fourteenth aspect execute their own processes simultaneously or separately, thereby favorably leading to the efficient printing process.

Eighteenth Aspect

An eighteenth aspect of the invention is directed to a printing program embodied on a computer readable medium for use with a computer operable as: a block partition unit that partitions image data of a value M (M≧3) into a plurality of partition regions; an edge detection unit that detects an edge partially in any of the partition regions as a result of partition by the block partition unit; an edge enhancement unit that enhances the edge detected by the edge detection unit; a first edge determination unit that determines whether the partition region edge-enhanced by the edge enhancement unit includes an edge or not; a first middle tone region determination unit that determines whether the partition region determined as not including the edge by the first edge determination unit as being a middle tone region or not; a first N-value data generation unit that generates N-value image data by converting, into a value N (M>N≧2) by going through a first N-value process, the image data of the partition region determined as being the middle tone region by the first middle tone region determination unit; a second N-value data generation unit that generates the N-value image data by converting, into the value N by going through a second N-value process, the image data of the partition region determined as including the edge by the first edge determination unit, or the image data of the partition region determined as not being the middle tone region by the first middle tone region determination unit; and a first printing data generation unit that generates printing data in which a dot setting is correspondingly made to pixels of the N-value image data generated by the first N-value data generation unit, and pixels of the N-value image data generated by the second N-value data generation unit, and for use with the computer or another computer operable as:

a second edge determination unit that determines whether the partition regions as a result of partition by the block partition unit except for the partition regions through with detection by the edge detection unit include the edge or not; a second middle tone region determination unit that determines whether the partition region determined as not including the edge by the second edge determination unit is the middle tone region or not; a third N-value data generation unit that generates the N-value image data by converting, into the value N by going through the first N-value process, the image data of the partition region determined as being the middle tone region by the second middle tone region determination unit; a fourth N-value data generation unit that generates the N-value image data by converting, into the value N by going through the second N-value process, the image data of the partition region determined as including the edge by the second edge determination unit, or the image data of the partition region determined as not being the middle tone region by the second middle tone region determination unit; a second printing data generation unit that generates printing data in which a dot setting is correspondingly made to pixels in the N-value image data generated by the third N-value data generation unit, and pixels in the N-value image data generated by the fourth N-value data generation unit; a dot size change unit that changes a size of any of the dots located at a portion of the edge in the printing data that is generated by the second printing data generation unit and corresponds to the N-value image data generated by the fourth N-value data generation unit, and enhances the edge; a printing data synthesis unit that synthesizes together the printing data in which a dot size change is performed by the dot size change unit, the printing data generated by the second printing data generation unit, and the printing data generated by the first printing data generation unit; and a printing unit that performs printing based on the printing data as a result of data synthesis by the printing data synthesis unit.

Similarly to the ninth aspect, such a configuration enables simultaneous processing on a block basis so that the printing process can be increased in efficiency in its entirety. What is more, the periodicity becomes less apparent so that the printing result can be high in quality.

Similarly also to the tenth aspect, the component units can be implemented by software using a computer system that is commonly provided to printing devices on the current market so that the component units can be implemented more economically and with more ease than a case with hardware that is specifically built for the purpose. Moreover, through partial rewriting of the program, it leads to easy version up by function modification or improvement, for example.

Nineteenth Aspect

A nineteenth aspect of the invention is directed to a computer-readable recording medium that is recorded with the printing program of any one of the tenth to eighteenth aspects.

This enables easy and secure user provision of the printing program of any one of the tenth to eighteenth aspects via computer-readable recording media such as CD-ROMs, DVD-ROMs, flexible disks (FDs), or semiconductor chips.

Twentieth Aspect

A twentieth aspect of the invention is directed to a printing method that includes: a block partition step of partitioning image data of a value M (M≧3) into a plurality of partition regions; an edge detection step of detecting an edge in the M-value image data; an edge enhancement step of enhancing the edge detected by the edge detection step; an edge determination step of determining whether each of the partition regions as a result of partition by the block partition step includes an edge or not; a middle tone region determination step of determining whether the partition region determined as not including the edge by the edge determination step as being a middle tone region or not; a first N-value data generation step of generating N-value image data by converting, into a value N (M>N≧2) by going through a first N-value process, the image data of the partition region determined as being the middle tone region by the middle tone region determination step; a second N-value data generation step of generating the N-value image data by converting, into the value N by going through a second N-value process, the image data of the partition region determined as including the edge by the edge determination step, or the image data of the partition region determined as not being the middle tone region by the middle tone region determination step; a printing data generation step of generating printing data in which a dot setting is correspondingly made to pixels of the N-value image data generated by the second N-value data generation step, and pixels of the N-value image data generated by the first N-value data generation step; and a printing step of performing printing based on the printing data generated by the printing data generation step.

With such a configuration, similarly to the first aspect, a banding problem as a result of ink deflection is reduced so that white or dark streaks can be eliminated or made less noticeable. The printing result can be thus high in quality with efficiency. Such a configuration also enables processing appropriate to each of the partition regions so that the printing process can be performed with efficiency.

As to the process steps, the computer hardware is mainly in charge of process execution, i.e., the block partition step is taken charge by an input unit and a CPU, the middle tone region determination step by a storage unit and the CPU, the first and second N-value data generation steps both by the CPU, and the printing step by an output unit. The edge enhancement step is executed using an edge detection filter, an edge enhancement filter, or others.

Twenty-First Aspect

According to a printing method of a twenty-first aspect, in the twentieth aspect, the edge enhancement step reduces to a further degree a pixel value of any of the pixels located at a portion of the edge.

Similarly to the second aspect, the difference in size is increased between the resulting size-reduced dot and a dot for the next pixel with an edge therebetween so that the edge portion can be enhanced with efficiency.

Twenty-Second Aspect

According to a printing method of a twenty-second aspect, in the twentieth aspect, the edge enhancement step increases a pixel value of any of the pixels located at a portion of the edge.

Similarly to the third aspect, the difference in size is increased between the resulting size-increased dot and a dot for the next pixel with an edge therebetween so that the edge portion can be enhanced with efficiency.

Twenty-Third Aspect

According to a printing method of a twenty-third aspect, in the twentieth aspect, any one of or two or more of the edge enhancement step, the edge determination step, the middle tone region determination step, and the printing data generation step are executed simultaneously.

Similarly to the fourth aspect, such a method enables to make the process steps in the printing method of the twentieth aspect execute the processes simultaneously or separately, thereby favorably leading to the efficient printing process.

Twenty-Fourth Aspect

A twenty-fourth aspect of the invention is directed to a printing method that includes: a block partition step of partitioning image data of a value M (M≧3) into a plurality of partition regions; an edge determination step of determining whether each of the partition regions as a result of partition by the block partition step includes an edge or not; a middle tone region determination step of determining whether the partition region determined as not including the edge by the edge determination step as being a middle tone region or not; a first N-value data generation step of generating N-value image data by converting, into a value N (M>N≧2) by going through a first N-value process, the image data of the partition region determined as being the middle tone region by the middle tone region determination step; a second N-value data generation step of generating the N-value image data by converting, into the value N by going through a second N-value process, the image data of the partition region determined as including the edge by the edge determination step, or the image data of the partition region determined as not being the middle tone region by the middle tone region determination step; a printing data generation step of generating printing data in which a dot setting is correspondingly made to pixels of the N-value image data generated by the second N-value data generation step, and pixels of the N-value image data generated by the first N-value data generation step; a dot size change step of changing a size of any of the dots located at a portion of the edge in the printing data that is generated by the printing data generation step and corresponds to the N-value image data generated by the first N-value data generation step, and enhancing the edge; and a printing step of performing printing based on the printing data in which a dot size change is performed by the dot size change step, and the printing data generated by the printing data generation step.

With such a method, similarly to the second aspect, a banding problem as a result of ink deflection is reduced so that white or dark streaks can be eliminated or made less noticeable. The printing result can be thus high in quality with efficiency. Such a method also enables processing appropriate to each of the partition regions so that the printing process can be performed with efficiency.

As to the process steps, the CPU in the hardware configuration implements process execution, i.e., the block partition step, the edge determination step, the middle tone region determination step, the first and second N-value data generation steps, the printing data generation step, and the dot size change step. The printing step is implemented by an output unit.

Twenty-Fifth Aspect

According to a printing method of a twenty-fifth aspect, in the twenty-fourth aspect, the dot size change step reduces the size of any of the dots located at the portion of the edge.

Similarly to the sixth aspect, the difference in size is increased between the resulting size-reduced dot and a dot for the next pixel with an edge therebetween so that the edge portion can be enhanced with efficiency.

Twenty-Sixth Aspect

According to a printing method of a twenty-sixth aspect, in the twenty-fourth aspect, the dot size change step increases the size of any of the dots located at the portion of the edge.

Similarly to the seventh aspect, the difference in size is increased between the resulting size-increased dot and a dot for the next pixel with an edge therebetween so that the edge portion can be enhanced with efficiency.

Twenty-Seventh Aspect

According to a printing method of a twenty-seventh aspect, in the twenty-first aspect, any one of or two or more of the edge determination step, the middle tone region determination step, the printing data generation step, and the dot size change step are executed simultaneously.

Similarly to the eighth aspect, such a method enables to make the process steps in the printing method of the twenty-fourth aspect execute the processes simultaneously or separately, thereby favorably leading to the efficient printing process.

Twenty-Eighth Aspect

A twenty-eighth aspect of the invention is directed to a printing method that includes: a block partition step of partitioning image data of a value M (M≧3) into a plurality of partition regions; an edge detection step of detecting an edge partially in any of the partition regions as a result of partition by the block partition step; an edge enhancement step of enhancing the edge detected by the edge detection step; a first edge determination step of determining whether the partition region edge-enhanced by the edge enhancement step includes an edge or not; a first middle tone region determination step of determining whether the partition region determined as not including the edge by the first edge determination step as being a middle tone region or not; a first N-value data generation step of generating N-value image data by converting, into a value N (M>N≧2) by going through a first N-value process, the image data of the partition region determined as being the middle tone region by the first middle tone region determination step; a second N-value data generation step of generating the N-value image data by converting, into the value N by going through a second N-value process, the image data of the partition region determined as including the edge by the first edge determination step, or the image data of the partition region determined as not being the middle tone region by the first middle tone region determination step; and a first printing data generation step of generating printing data in which a dot setting is correspondingly made to pixels of the N-value image data generated by the first N-value data generation step, and pixels of the N-value image data generated by the second N-value data generation step, and includes a second edge determination step of determining whether the partition regions as a result of partition by the block partition step except for the partition regions through with detection by the edge detection step include the edge or not; a second middle tone region determination step of determining whether the partition region determined as not including the edge by the second edge determination step is the middle tone region or not; a third N-value data generation step of generating the N-value image data by converting, into the value N by going through the first N-value process, the image data of the partition region determined as being the middle tone region by the second middle tone region determination step; a fourth N-value data generation step of generating the N-value image data by converting, into the value N by going through the second N-value process, the image data of the partition region determined as including the edge by the second edge determination step, or the image data of the partition region determined as not being the middle tone region by the second middle tone region determination step; a second printing data generation step of generating printing data in which a dot setting is correspondingly made to pixels in the N-value image data generated by the third N-value data generation step, and pixels in the N-value image data generated by the fourth N-value data generation step; a dot size change step of changing a size of any of the dots located at a portion of the edge in the printing data that is generated by the second printing data generation step and corresponds to the N-value image data generated by the fourth N-value data generation step, and enhances the edge; a printing data synthesis step of synthesizing together the printing data in which a dot size change is performed by the dot size change step, the printing data generated by the second printing data generation step, and the printing data generated by the first printing data generation step; and a printing step of performing printing based on the printing data as a result of data synthesis by the printing data synthesis step.

Similar to the ninth aspect, such a method enables simultaneous processing on a block basis so that the printing process can be increased in efficiency in its entirety. What is more, the periodicity becomes less apparent to a further degree so that the printing result can be high in quality.

Twenty-Ninth Aspect

A twenty-ninth aspect of the invention is directed to an image processing device that includes: a block partition unit that partitions image data of a value M (M≧3) into a plurality of partition regions; an edge detection unit that detects an edge in the M-value image data; an edge enhancement unit that enhances the edge detected by the edge detection unit; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; and a printing data generation unit that generates printing data in which a dot setting is correspondingly made to pixels of the N-value image data generated by the first N-value data generation unit, and pixels of the N-value image data generated by the second N-value data generation unit.

With such a configuration, a banding problem as a result of ink deflection is favorably reduced so that the resulting printing data can be efficiently generated with white or dark streaks eliminated or made less noticeable therein. Such a configuration also enables processing appropriate to each of the partition regions so that the printing process can be performed with efficiency.

Thirtieth Aspect

According to an image processing device of a thirtieth aspect, in the twenty-ninth aspect, the edge enhancement unit reduces a pixel value of any of the pixels located at a portion of the edge.

The difference in size is thus increased between the resulting size-reduced dot and a dot for the next pixel with an edge therebetween so that the edge portion can be enhanced with efficiency.

Thirty-First Aspect

According to an image processing device of a thirty-first aspect, in the twenty-ninth aspect, the edge enhancement unit increases a pixel value of any of the pixels located at a portion of the edge.

The difference in size is thus increased between the resulting size-increased dot and a dot for the next pixel with an edge therebetween so that the edge portion can be enhanced with efficiency.

Thirty-Second Aspect

According to an image processing device of a thirty-second aspect, in the twenty-ninth aspect, any one of or two or more of the edge enhancement unit, the edge determination unit, the middle tone region determination unit, and the printing data generation unit are plurally provided.

Such a configuration enables to make the component units in the image processing device of the twenty-ninth aspect execute their own processes simultaneously or separately, thereby favorably leading to the efficient printing process.

Thirty-Third Aspect

A thirty-third aspect of the invention is directed to an image processing device that includes: a block partition unit that partitions image data of a value M (M≧3) into a plurality of partition regions; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; and a dot size change unit that changes a size of any of the dots located at a portion of the edge in the printing data that is generated by the printing data generation unit and corresponds to the N-value image data generated by the second N-value data generation unit, and enhances the edge.

With such a configuration, similarly to the first aspect, a banding problem as a result of ink deflection is favorably reduced so that the resulting printing data can be efficiently generated with white or dark streaks eliminated or made less noticeable therein. Such a configuration also enables processing appropriate to each of the partition regions so that the printing process can be performed with efficiency.

Thirty-Fourth Aspect

According to an image processing device of a thirty-fourth aspect, in the thirty-third aspect, the dot size change unit reduces the size of any of the dots located at the portion of the edge.

The difference in size is thus increased between the resulting size-reduced dot and a dot for the next pixel with an edge therebetween so that the edge portion can be enhanced with efficiency.

Thirty-Fifth Aspect

According to an image processing device of a thirty-fifth aspect, in the thirty-third aspect, the dot size change unit increases the size of any of the dots located at the portion of the edge.

The difference in size is thus increased between the resulting size-increased dot and a dot for the next pixel with an edge therebetween so that the edge portion can be enhanced with efficiency.

Thirty-Sixth Aspect

According to an image processing device of a thirty-sixth aspect, in the thirty-third aspect, any one of or two or more of the edge determination unit, the middle tone region determination unit, the printing data generation unit, and the dot size change unit are plurally provided.

Such a configuration enables to make the component units in the image processing device of the thirty-third aspect execute their own processes simultaneously or separately, thereby favorably leading to the efficient printing process.

Thirty-Seventh Aspect

A thirty-seventh aspect of the invention is directed to an image processing device that includes: a block partition unit that partitions image data of a value M (M≧3) into a plurality of partition regions; an edge detection unit that detects an edge partially in any of the partition regions as a result of partition by the block partition unit; an edge enhancement unit that enhances the edge detected by the edge detection unit; a first edge determination unit that determines whether the partition region edge-enhanced by the edge enhancement unit includes an edge or not; a first middle tone region determination unit that determines whether the partition region determined as not including the edge by the first edge determination unit as being a middle tone region or not; a first N-value data generation unit that generates N-value image data by converting, into a value N (M>N≧2) by going through a first N-value process, the image data of the partition region determined as being the middle tone region by the first middle tone region determination unit; a second N-value data generation unit that generates the N-value image data by converting, into the value N by going through a second N-value process, the image data of the partition region determined as including the edge by the first edge determination unit, or the image data of the partition region determined as not being the middle tone region by the first middle tone region determination unit; and a first printing data generation unit that generates printing data in which a dot setting is correspondingly made to pixels of the N-value image data generated by the first N-value data generation unit, and pixels of the N-value image data generated by the second N-value data generation unit, and includes

a second edge determination unit that determines whether the partition regions as a result of partition by the block partition unit except for the partition regions through with detection by the edge detection unit include the edge or not; a second middle tone region determination unit that determines whether the partition region determined as not including the edge by the second edge determination unit is the middle tone region or not; a third N-value data generation unit that generates the N-value image data by converting, into the value N by going through the first N-value process, the image data of the partition region determined as being the middle tone region by the second middle tone region determination unit; a fourth N-value data generation unit that generates the N-value image data by converting, into the value N by going through the second N-value process, the image data of the partition region determined as including the edge by the second edge determination unit, or the image data of the partition region determined as not being the middle tone region by the second middle tone region determination unit; a second printing data generation unit that generates printing data in which a dot setting is correspondingly made to pixels in the N-value image data generated by the third N-value data generation unit, and pixels in the N-value image data generated by the fourth N-value data generation unit; a dot size change unit that changes a size of any of the dots located at a portion of the edge in the printing data that is generated by the second printing data generation unit and corresponds to the N-value image data generated by the fourth N-value data generation unit, and enhances the edge; a printing data synthesis unit that synthesizes together the printing data in which a dot size change is performed by the dot size change unit, the printing data generated by the second printing data generation unit, and the printing data generated by the first printing data generation unit; and a printing unit that performs printing based on the printing data as a result of data synthesis by the printing data synthesis unit.

Such a configuration enables simultaneous processing on a block basis in addition to the effects achieved by the twenty-ninth and thirty-third aspects so that the printing process can be increased in efficiency in its entirety. What is more, the resulting printing data can be less apparent in periodicity to a further degree than only with the twenty-ninth or thirty-third aspect.

Thirty-Eighth Aspect

A thirty-eighth aspect of the invention is directed to an image processing program embodied on a computer readable medium for use with a computer operable as: a block partition unit that partitions image data of a value M (M≧3) into a plurality of partition regions; an edge detection unit that detects an edge in the M-value image data; an edge enhancement unit that enhances the edge detected by the edge detection unit; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; and a printing data generation unit that generates printing data in which a dot setting is correspondingly made to pixels of the N-value image data generated by the first N-value data generation unit, and pixels of the N-value image data generated by the second N-value data generation unit.

With such a configuration, similarly to the twenty-ninth aspect, a banding problem as a result of ink deflection is favorably reduced so that the resulting printing data can be generated efficiently with high quality with white or dark streaks eliminated or made less noticeable therein. Such a configuration also enables processing appropriate to each of the partition regions so that the printing process can be performed with efficiency.

The component units can be implemented by software using a general-purpose computer system such as personal computer (PC) so that the component units can be implemented more economically and with more ease than a case with hardware that is specifically built for the purpose. Moreover, through partial rewriting of the program, it leads to easy version up by function modification or improvement, for example.

Thirty-Ninth Aspect

According to an image processing program of a thirty-ninth aspect, in the thirty-eighth aspect, the edge enhancement unit reduces a pixel value of any of the pixels located at a portion of the edge.

Similarly to the thirtieth aspect, the difference in size is thus increased between the resulting size-reduced dot and a dot for the next pixel with an edge therebetween so that the edge portion can be enhanced with efficiency.

Fortieth Aspect

According to an image processing program of a fortieth aspect, in the thirty-eighth aspect, the edge enhancement unit increases a pixel value of any of the pixels located at a portion of the edge.

Similarly to the thirty-first aspect, the difference in size is thus increased between the resulting size-increased dot and a dot for the next pixel with an edge therebetween so that the edge portion can be enhanced with efficiency.

Forty-First Aspect

According to an image processing program of a forty-first aspect, in the thirty-eighth aspect, any one of or two or more of the edge enhancement unit, the edge determination unit, the middle tone region determination unit, and the printing data generation unit are plurally provided.

Similarly to the thirty-second aspect, such a configuration enables to make the component units in the image processing device of the thirty-eighth aspect execute their own processes simultaneously or separately, thereby favorably leading to the efficient printing process.

Forty-Second Aspect

A forty-second aspect of the invention is directed to an image processing program embodied on a computer readable medium for use with a computer operable as: a block partition unit that partitions image data of a value M (M≧3) into a plurality of partition regions; an edge determination unit that determines whether each of the partition regions as a result of partition by the block partition unit includes an edge or not; a middle tone region determination unit that determines whether the partition region determined as not including the edge by the edge determination unit as being a middle tone region or not; a first N-value data generation unit that generates N-value image data by converting, into a value N (M>N≧2) by going through a first N-value process, the image data of the partition region determined as being the middle tone region by the middle tone region determination unit; a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; a printing data generation unit that generates printing data in which a dot setting is correspondingly made to pixels of the N-value image data generated by the first N-value data generation unit, and pixels of the N-value image data generated by the second N-value data generation unit; and a dot size change unit that changes a size of any of the dots located at a portion of the edge in the printing data that is generated by the printing data generation unit and corresponds to the N-value image data generated by the second N-value data generation unit, and enhances the edge.

With such a configuration, similarly to the thirty-third aspect, a banding problem as a result of ink deflection is favorably reduced so that the resulting printing data can be generated efficiently with high quality with white or dark streaks eliminated or made less noticeable therein. Such a configuration also enables processing appropriate to each of the partition regions so that the printing process can be performed with efficiency.

Similarly also to the thirty-eighth aspect, the component units can be implemented by software using a general-purpose computer system such as PC so that the component units can be implemented more economically and with more ease than a case with hardware that is specifically built for the purpose. Moreover, through partial rewriting of the program, it leads to easy version up by function modification or improvement, for example.

Forty-Third Aspect

According to an image processing program of a forty-third aspect, in the forty-second aspect, the dot size change unit reduces the size of any of the dots located at the portion of the edge.

Similarly to the thirty-fourth aspect, the difference in size is thus increased between the resulting size-reduced dot and a dot for the next pixel with an edge therebetween so that the edge portion can be enhanced with efficiency.

Forty-Fourth Aspect

According to an image processing program of a forty-fourth aspect, in the forty-second aspect, the dot size change unit increases the size of any of the dots located at the portion of the edge.

Similarly to the thirty-fifth aspect, the difference in size is thus increased between the resulting size-increased dot and a dot for the next pixel with an edge therebetween so that the edge portion can be enhanced with efficiency.

Forty-Fifth Aspect

According to an image processing program of a forty-fifth aspect, in the forty-second aspect, any one of or two or more of the edge determination unit, the middle tone region determination unit, the printing data generation unit, and the dot size change unit are plurally provided.

Similarly to the thirty-seventh aspect, such a configuration enables to make the component units in the image processing device of the forty-second aspect execute their own processes simultaneously or separately, thereby favorably leading to the efficient printing process.

Forty-Sixth Aspect

A forty-sixth aspect of the invention is directed to an image processing program embodied on a computer readable medium for use with a computer operable as: a block partition unit that partitions image data of a value M (M≧3) into a plurality of partition regions; an edge detection unit that detects an edge partially in any of the partition regions as a result of partition by the block partition unit; an edge enhancement unit that enhances the edge detected by the edge detection unit; a first edge determination unit that determines whether the partition region edge-enhanced by the edge enhancement unit includes an edge or not; a first middle tone region determination unit that determines whether the partition region determined as not including the edge by the first edge determination unit as being a middle tone region or not; a first N-value data generation unit that generates N-value image data by converting, into a value N (M>N≧2) by going through a first N-value process, the image data of the partition region determined as being the middle tone region by the first middle tone region determination unit; a second N-value data generation unit that generates the N-value image data by converting, into the value N by going through a second N-value process, the image data of the partition region determined as including the edge by the first edge determination unit, or the image data of the partition region determined as not being the middle tone region by the first middle tone region determination unit; and a first printing data generation unit that generates printing data in which a dot setting is correspondingly made to pixels of the N-value image data generated by the first N-value data generation unit, and pixels of the N-value image data generated by the second N-value data generation unit, and for use with the computer or another computer operable as:

a second edge determination unit that determines whether the partition regions as a result of partition by the block partition unit except for the partition regions through with detection by the edge detection unit include the edge or not; a second middle tone region determination unit that determines whether the partition region determined as not including the edge by the second edge determination unit is the middle tone region or not; a third N-value data generation unit that generates the N-value image data by converting, into the value N by going through the first N-value process, the image data of the partition region determined as being the middle tone region by the second middle tone region determination unit; a fourth N-value data generation unit that generates the N-value image data by converting, into the value N by going through the second N-value process, the image data of the partition region determined as including the edge by the second edge determination unit, or the image data of the partition region determined as not being the middle tone region by the second middle tone region determination unit; a second printing data generation unit that generates printing data in which a dot setting is correspondingly made to pixels in the N-value image data generated by the third N-value data generation unit, and pixels in the N-value image data generated by the fourth N-value data generation unit; a dot size change unit that changes a size of any of the dots located at a portion of the edge in the printing data that is generated by the second printing data generation unit and corresponds to the N-value image data generated by the fourth N-value data generation unit, and enhances the edge; a printing data synthesis unit that synthesizes together the printing data in which a dot size change is performed by the dot size change unit, the printing data generated by the second printing data generation unit, and the printing data generated by the first printing data generation unit; and a printing unit that performs printing based on the printing data as a result of data synthesis by the printing data synthesis unit.

In addition to effects achieved by the thirty-eighth and forty-second aspects, such a configuration enables simultaneous processing on a block basis so that the printing process can be increased in efficiency in its entirety. What is more, the resulting printing data can be less apparent in periodicity to a further degree than only with the thirty-eighth or forty-second aspect.

Forty-Seventh Aspect

A forty-seventh aspect of the invention is directed to a computer-readable recording medium that is recorded with the image processing program of any one of the thirty-eighth to forty-sixth aspects.

This enables easy and secure user provision of the image processing program of any one of the thirty-eighth to forty-sixth aspects via computer-readable recording media such as CD-ROMs, DVD-ROMs, FDs, or semiconductor chips.

Forty-Eighth Aspect

A forty-eighth aspect of the invention is directed to an image processing method that includes: a block partition step of partitioning image data of a value M (M≧3) into a plurality of partition regions; an edge detection step of detecting an edge in the M-value image data; an edge enhancement step of enhancing the edge detected by the edge detection unit; an edge determination step of determining whether each of the partition regions as a result of partition by the block partition step includes an edge or not; a middle tone region determination step of determining whether the partition region determined as not including the edge by the edge determination step as being a middle tone region or not; a first N-value data generation step of generating N-value image data by converting, into a value N (M>N≧2) by going through a first N-value process, the image data of the partition region determined as being the middle tone region by the middle tone region determination step; a second N-value data generation step of generating the N-value image data by converting, into the value N by going through a second N-value process, the image data of the partition region determined as including the edge by the edge determination step, or the image data of the partition region determined as not being the middle tone region by the middle tone region determination step; and a printing data generation step of generating printing data in which a dot setting is correspondingly made to pixels of the N-value image data generated by the second N-value data generation step, and pixels of the N-value image data generated by the first N-value data generation step.

With such a method, similarly to the twenty-fourth aspect, a banding problem as a result of ink deflection is favorably reduced so that the resulting printing data can be generated efficiently with high quality with white or dark streaks eliminated or made less noticeable therein. Such a method also enables processing appropriate to each of the partition regions so that the printing process can be performed with efficiency.

As to the process steps, the computer hardware is mainly in charge of process execution, i.e., the block partition step is taken charge by an input unit and a CPU, the middle tone region determination step by a storage unit and the CPU, the first and second N-value data generation steps both by the CPU, and the printing data generation step by the CPU and an output unit. The edge enhancement step is executed using an edge detection filter, an edge enhancement filter, or others.

Forty-Ninth Aspect

According to an image processing method of a forty-ninth aspect, in the forty-eighth aspect, the edge enhancement step reduces to a pixel value of any of the pixels located at a portion of the edge.

Similarly to the thirtieth aspect, the difference in size is increased between the resulting size-reduced dot and a dot for the next pixel with an edge therebetween so that the edge portion can be enhanced with efficiency.

Fiftieth Aspect

According to an image processing method of a fiftieth aspect, in the forty-eighth aspect, the edge enhancement step increases a pixel value of any of the pixels located at a portion of the edge.

Similarly to the thirty-first aspect, the difference in size is increased between the resulting size-increased dot and a dot for the next pixel with an edge therebetween so that the edge portion can be enhanced with efficiency.

Fifty-First Aspect

According to an image processing method of a fifty-first aspect, in the forty-eighth aspect, any one of or two or more of the edge enhancement step, the edge determination step, the middle tone region determination step, and the printing data generation step are executed simultaneously.

Similarly to the thirty-second aspect, such a method enables to make the process steps in the image processing method of the forty-eighth aspect execute the processes simultaneously or separately, thereby favorably leading to the efficient printing process.

Fifty-Second Aspect

A fifty-second aspect of the invention is directed to an image processing method that includes: a block partition step of partitioning image data of a value M (M≧3) into a plurality of partition regions; an edge determination step of determining whether each of the partition regions as a result of partition by the block partition step includes an edge or not; a middle tone region determination step of determining whether the partition region determined as not including the edge by the edge determination step as being a middle tone region or not; a first N-value data generation step of generating N-value image data by converting, into a value N (M>N≧2) by going through a first N-value process, the image data of the partition region determined as being the middle tone region by the middle tone region determination step; a second N-value data generation step of generating the N-value image data by converting, into the value N by going through a second N-value process, the image data of the partition region determined as including the edge by the edge determination step, or the image data of the partition region determined as not being the middle tone region by the middle tone region determination step; a printing data generation step of generating printing data in which a dot setting is correspondingly made to pixels of the N-value image data generated by the second N-value data generation step, and pixels of the N-value image data generated by the first N-value data generation step; and a dot size change step of changing a size of any of the dots located at a portion of the edge in the printing data that is generated by the printing data generation unit and corresponds to the N-value image data generated by the first N-value data generation step, and enhancing the edge.

With such a method, similarly to the twenty-eighth aspect, a banding problem as a result of ink deflection is favorably reduced so that the resulting printing data can be generated efficiently with high quality with white or dark streaks eliminated or made less noticeable therein. Such a method also enables processing appropriate to each of the partition regions so that the printing process can be performed with efficiency.

Fifty-Third Aspect

According to an image processing method of a fifty-third aspect, in the fifty-second aspect, the dot size change step reduces the size of any of the dots located at the portion of the edge.

Similarly to the thirty-fourth aspect, the difference in size is increased between the resulting size-reduced dot and a dot for the next pixel with an edge therebetween so that the edge portion can be enhanced with efficiency.

Fifty-Fourth Aspect

According to an image processing method of a fifty-fourth aspect, in the fifty-second aspect, the dot size change step increases the size of any of the dots located at the portion of the edge.

Similarly to the thirty-fifth aspect, the difference in size is increased between the resulting size-increased dot and a dot for the next pixel with an edge therebetween so that the edge portion can be enhanced with efficiency.

Fifty-Fifth Aspect

According to an image processing method of a fifty-fifth aspect, in the fifty-second aspect, any one of or two or more of the edge enhancement step, the edge determination step, the middle tone region determination step, the printing data generation step, and the dot size change step are executed simultaneously.

Similarly to the thirty-sixth aspect, such a method enables to make the process steps in the image processing device of the fifty-second aspect execute the processes simultaneously or separately, thereby favorably leading to the efficient printing process.

Fifty-Sixth Aspect

A fifty-sixth aspect of the invention is directed to an image processing method that includes: a block partition step of partitioning image data of a value M (M≧3) into a plurality of partition regions; an edge detection step of detecting an edge partially in any of the partition regions as a result of partition by the block partition step; an edge enhancement step of enhancing the edge detected by the edge detection step; a first edge determination step of determining whether the partition region edge-enhanced by the edge enhancement step includes an edge or not; a first middle tone region determination step of determining whether the partition region determined as not including the edge by the first edge determination step as being a middle tone region or not; a first N-value data generation step of generating N-value image data by converting, into a value N (M>N≧2) by going through a first N-value process, the image data of the partition region determined as being the middle tone region by the first middle tone region determination step; a second N-value data generation step of generating the N-value image data by converting, into the value N by going through a second N-value process, the image data of the partition region determined as including the edge by the first edge determination step, or the image data of the partition region determined as not being the middle tone region by the first middle tone region determination step; and a first printing data generation step of generating printing data in which a dot setting is correspondingly made to pixels of the N-value image data generated by the first N-value data generation step, and pixels of the N-value image data generated by the second N-value data generation step, and includes

a second edge determination step of determining whether the partition regions as a result of partition by the block partition step except for the partition regions through with detection by the edge detection step include the edge or not; a second middle tone region determination step of determining whether the partition region determined as not including the edge by the second edge determination step is the middle tone region or not; a third N-value data generation step of generating the N-value image data by converting, into the value N by going through the first N-value process, the image data of the partition region determined as being the middle tone region by the second middle tone region determination step; a fourth N-value data generation step of generating the N-value image data by converting, into the value N by going through the second N-value process, the image data of the partition region determined as including the edge by the second edge determination step, or the image data of the partition region determined as not being the middle tone region by the second middle tone region determination step; a second printing data generation step of generating printing data in which a dot setting is correspondingly made to pixels in the N-value image data generated by the third N-value data generation step, and pixels in the N-value image data generated by the fourth N-value data generation step; a dot size change step of changing a size of any of the dots located at a portion of the edge in the printing data that is generated by the second printing data generation step and corresponds to the N-value image data generated by the fourth N-value data generation step, and enhances the edge; a printing data synthesis step of synthesizing together the printing data in which a dot size change is performed by the dot size change step, the printing data generated by the second printing data generation step, and the printing data generated by the first printing data generation step; and a printing step of performing printing based on the printing data as a result of data synthesis by the printing data synthesis step.

In addition to the effects achieved by the forty-eighth and fifty-second aspects, such a method enables simultaneous processing on a block basis so that the printing process can be increased in efficiency in its entirety. What is more, the resulting printing data can be less apparent in periodicity to a further degree than only with the forty-eighth or fifty-second aspect.

### BRIEF DESCRIPTION OF THE DRAWINGS

The invention will be described with reference to the accompanying drawings, wherein like numbers reference like elements.

FIG. 1 is a function block diagram showing a printing device in a first embodiment of the invention.

FIG. 2 is a block diagram showing the hardware configuration of a computer system implementing the printing device of the invention.

FIG. 3 is a partial enlarged bottom view showing the configuration of a printing head of the invention.

FIG. 4 is a partial enlarged side view showing the configuration the printing head of the invention.

FIG. 5 is a conceptual view of an exemplary ideal dot pattern free from ink deflection.

FIG. 6 is a conceptual view of an exemplary dot pattern to be formed in a case where a nozzle is suffering from ink deflection.

FIG. 7 is a diagram showing a conversion table for reference at the time of an N-value process, showing the relationship between pixel values and values N, and between the values N and dot sizes.

FIGS. 8A-8H are diagrams showing an exemplary partition pattern for use for partitioning image data into partition regions.

FIG. 9 is a conceptual view of changing (enhancing) the density difference of an edge from side to side.

FIG. 10 is a diagram showing an exemplary error diffusion matrix for use in an error diffusion process.

FIG. 11 is a flowchart diagram of an exemplary process flow in the printing device of the invention.

FIG. 12 is a flowchart diagram showing an exemplary flow of a target pixel determination process.

FIG. 13 is a flowchart diagram showing an exemplary flow of an N-value process, and that of a dot conversion process.

FIG. 14 is a diagram showing a first example of an N-value conversion table using converted threshold values.

FIG. 15 is a diagram showing a second example of the N-value conversion table using the converted threshold values.

FIG. 16 is a first schematic view showing an exemplary flow of an N-value process and that of a dot conversion process.

FIG. 17 is a second schematic view showing the exemplary flow of the N-value process and that of the dot conversion process.

FIG. 18 is a diagram showing an exemplary dot pattern before an N-value process and a dot conversion process, and another exemplary dot pattern thereafter.

FIGS. 19A and 19B are both diagrams illustrating printing scheme differences between a multi-pass ink jet printer, and a line-head ink jet printer.

FIG. 20 is a conceptual view showing another exemplary configuration of a printing head.

FIG. 21 is a conceptual view showing an exemplary computer-readable recording medium with programs of the invention recorded thereon.

FIG. 22 is a function block diagram of a printing device in a second embodiment of the invention.

FIGS. 23A and 23B are both conceptual views in which the dot size is changed (enhanced) at an edge from side to side.

FIG. 24 is a flowchart diagram showing an exemplary process flow of the second embodiment.

FIG. 25 is a conceptual view of third and fourth embodiments.

### DESCRIPTION OF EXEMPLARY EMBODIMENTS

In the following, embodiments considered best to implement the invention are described in detail by referring to the accompanying drawings.

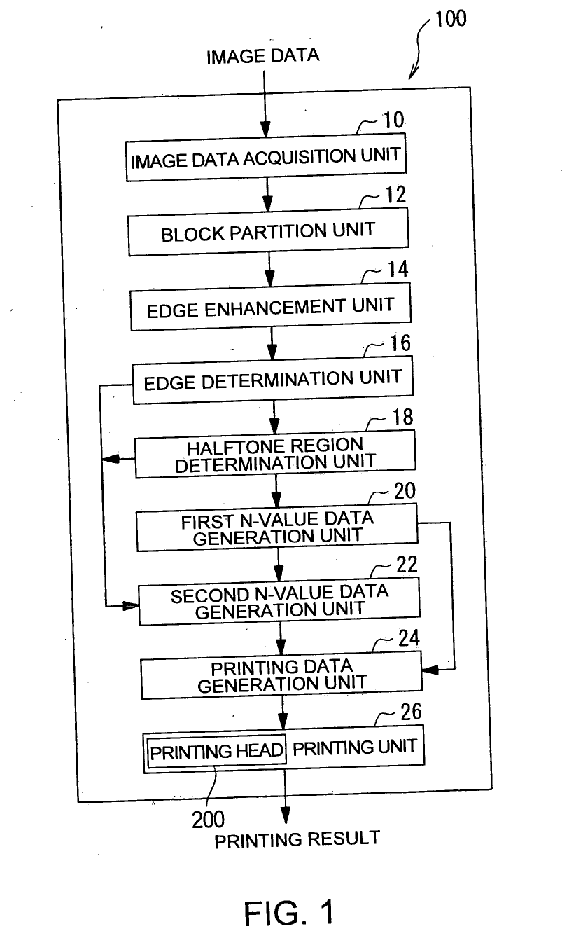

FIGS. 1 to 19 are all diagrams showing a first embodiment of the invention, i.e., a printing device 100, a printing program, a printing method, an image processing device, an image processing program, an image processing method, and a computer-readable recording medium.

FIG. 1 is a function block diagram showing the printing device 100 in the first embodiment of the invention.

As shown in the drawing, the printing device 100 is configured to include, mainly, a printing head 200, an image data acquisition unit 10, a block partition unit 12, an edge enhancement unit 14, an edge determination unit 16, a middle tone region determination unit 18, a first N-value data generation unit 20, a second N-value data generation unit 22, a printing data generation unit 24, and a printing unit 26. The printing unit 26 is an ink-jet type, performing printing based on printing data generated by the printing data generation unit 24.

Described now is the printing head 200 for application in the invention.

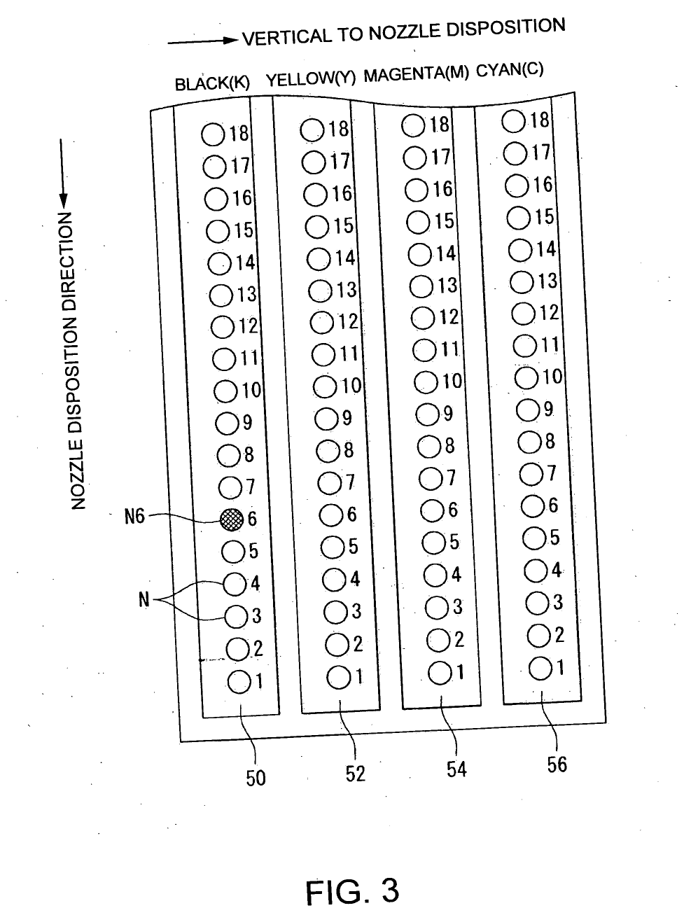

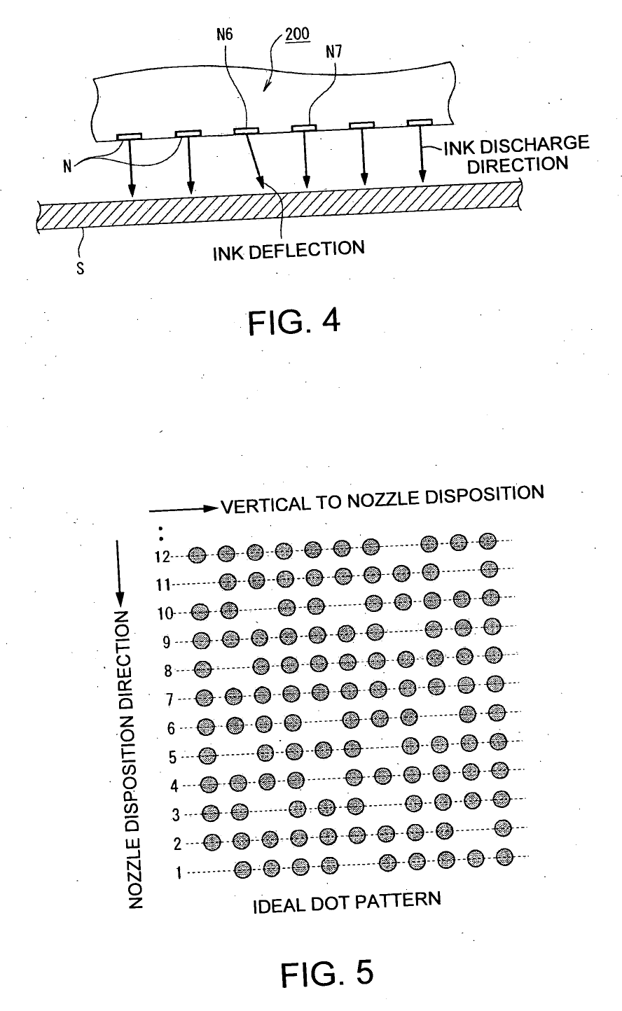

FIG. 3 is a partial enlarged bottom view showing the configuration of the printing head 200, and FIG. 4 is a partial enlarged side view thereof.

As shown in FIG. 3, the printing head 200 is long in paper-width direction of a printing paper for use in a so-called line-head printer. The printing head 200 is configured to include four nozzle modules of: a black nozzle module 50; a yellow nozzle module 52; a magenta nozzle module 54; and a cyan nozzle module 56. More specifically, the black nozzle module 50 carries a plurality of nozzles N (18 in the drawing) in a line in the direction along which the nozzles are disposed, each of which discharges only black (K) ink. The yellow nozzle module 52 carries a plurality of nozzles N in a line in the nozzle disposition direction, each of which discharges only yellow (Y) ink. The magenta nozzle module 54 carries a plurality of nozzles N in a line in the nozzle disposition direction, each of which discharges only magenta (M) ink. The cyan nozzle module 56 carries a plurality of nozzles N in a line in the nozzle disposition direction, each of which discharges only cyan (C) ink. These nozzle modules 50, 52, 54, and 56 are disposed as a unit in line in the printing direction, i.e., direction perpendicular to the nozzle disposition direction. When the printing head is designed for monochrome printing, the black (K) ink is solely used. When the printing head is aiming to derive high-quality images, six or seven colors of ink including light magenta, light cyan, and others may be used.

Among these four nozzle modules 50, 52, 54, and 56, FIG. 4 shows the black module 50 viewed from the side. In the black nozzle module 50, a nozzle N6 located 6th from the left is causing ink deflection, and the nozzle N6 discharges ink in the diagonal direction. In such a case, dots formed by the faulty nozzle N6 are printed (ink released) in the vicinity of a normal nozzle N7. The nozzle N7 is located next to the nozzle N6.

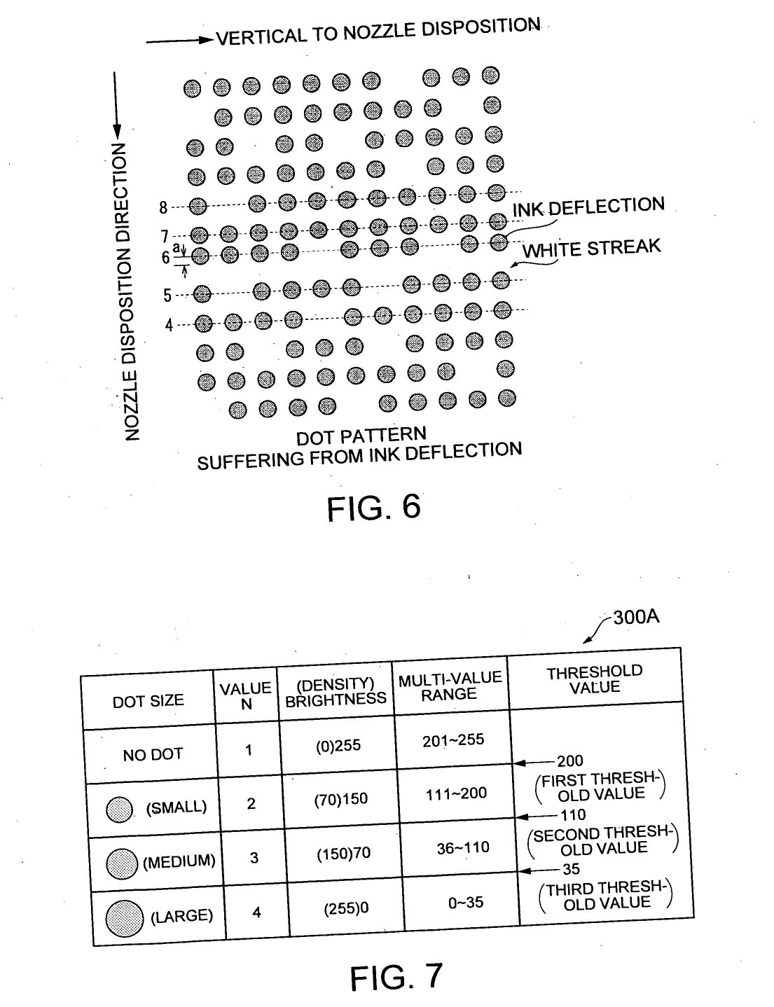

When printing is performed with the black module 50 of FIG. 5 being free from ink deflection, every dot is to be printed at their each defined printing positions, i.e., ideal dot pattern. When printing is performed with the black module 50 of FIG. 6 including the nozzle N6 located 6th from the left is suffering from ink deflection, for example, dots to be printed by such a faulty nozzle N6 are displaced from their defined printing positions by a distance a toward dots to be printed by the normal nozzle N7 located next to the nozzle N6.

Here, it is understood that the characteristics of the printing head 200 are fixed during manufacturing to some extent, and once manufactured, the characteristics hardly change except when discharge failures such as ink clogging occur, for example.

The image data acquisition unit 10 has a function of acquiring multi-level value (M-value where M≧3) color image data for printing. Such image data is provided over a network or others from a printing command device (not shown) exemplified by a PC, a printer server, or others connected with the printing device 100. The image data is also acquired through data reading directly from an image (data) reader exemplified by a scanner, a CD-ROM driver (both not shown), or others. When the acquired multi-value color image data is multi-value RGB data, e.g., image data in which gray level (brightness value) is represented by 8 bits (0 to 255) on a pixel basis for the respective colors of R, G, and B, the image data acquisition unit 10 also has a function of converting the multi-value RGB data into multi-value CMYK (four colors) data corresponding to inks of the printing head 200 through color conversion.

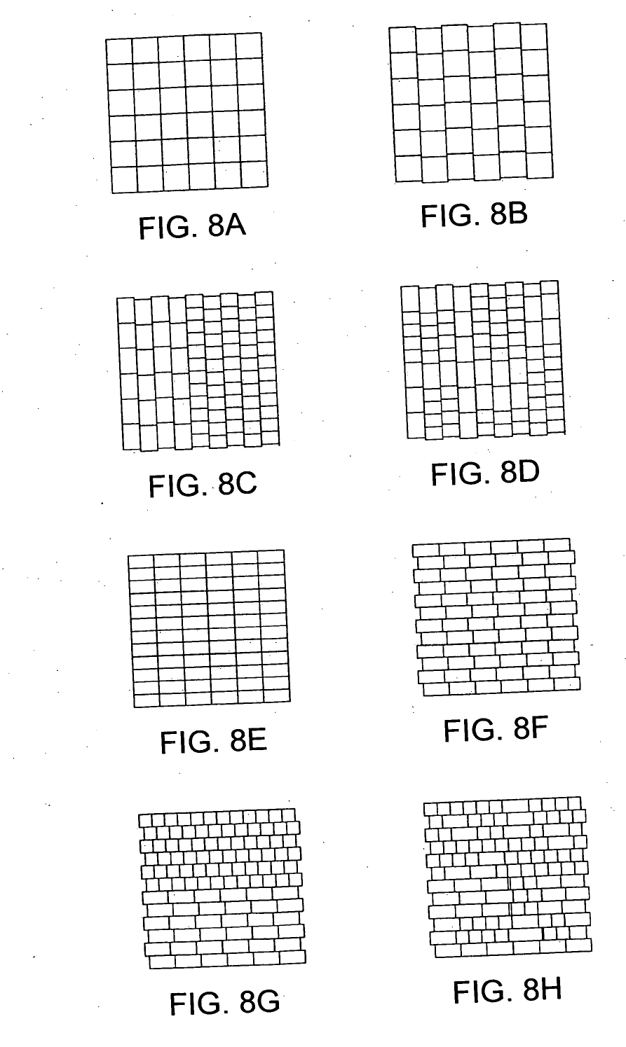

The block partition unit 12 serves to partition the multi-value image data acquired by the image data acquisition unit 10 into at least two or more partition regions (blocks). As to such data partition, there is no specific restriction for the number, size, and shape of the partition regions. If the image data is entirely rectangular, as shown in (a) of FIG. 8, the image data may be partitioned based on 5 by 5 matrix, or as shown in (e) of FIG. 8, 5 by 10 strap. Still alternatively, as shown in (b) or (f) of FIG. 8, pixels in the image data may be changed in position by a few vertically and horizontally for data partition. The resulting partition regions are not necessarily be of the same size, and as shown in (c), (d), (g), and (h), varying the size will do depending on the image type. Still alternatively, the resulting partition regions are not necessarily be of rectangular, and the image data may be partitioned into circles, or polygons such as triangles, or partitioned by curves such as fan shapes.

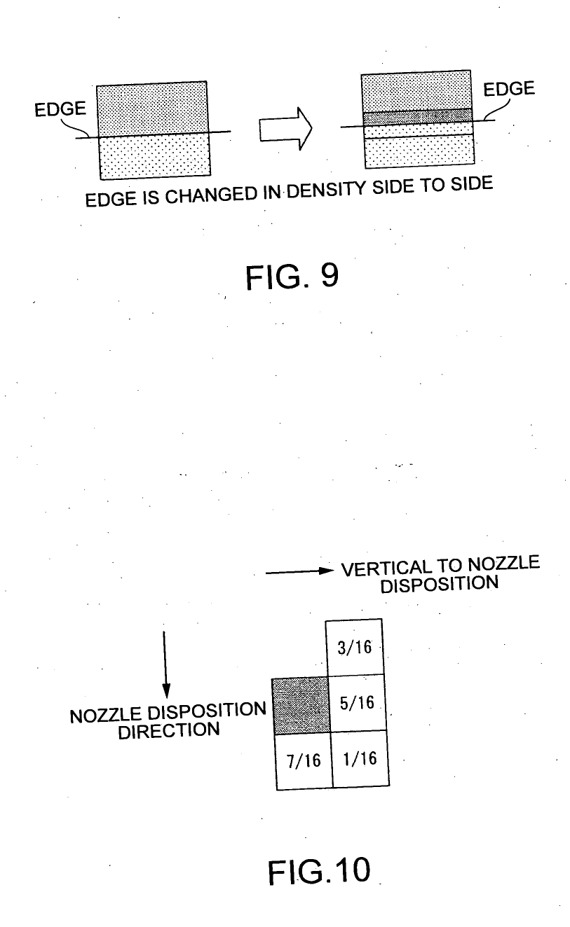

The edge enhancement unit 14 serves to detect and enhance any edge in the image data acquired by the image data acquisition unit 10. The expression of “edge” here denotes a portion showing an abrupt change in density, e.g., object or face contour, similarly to the expression of “edge” that is prevalently used in the field of general image processing. For edge detection, any typical technique that has been popular in the field of image processing is used as shown in FIG. 9. At the detected edge, pixels are adjusted in value, i.e., the edge is changed in density from side to side, by the edge enhancement unit 14 so that the edge portion is enhanced. Herein, the typical technique for edge detection includes differential edge detection operator (e.g., edge detection operator of Sobel, Roberts, or Prewitt), template edge detection operator (e.g., edge detection operator of Robinson or Kirsch, or template edge detection operator of Prewitt), zero crossing, percentile filter, or others.

The edge determination unit 16 serves to determine whether the partition regions as a result of partition by the block partition unit 12 include therein any edge. More in detail, the edge determination unit 16 groups, into two, the partition regions as a result of partition by the block partition unit 12, i.e., those through with edge enhancement by the edge enhancement unit 14, and those hardly through therewith. Although there may be exceptions depending on the type of original images or partition technique, almost every partition region includes edges in scenic and easy shots, for example. In view thereof, prior to grouping as such, a threshold value may be provided to the amount of edges for use as a basis so that the process can be implemented with efficiency.

When any partition region is determined as including no edge by the edge determination unit 16, the middle tone region determination unit 18 serves to determine whether the partition region is a middle tone region or not. More in detail, the middle tone region determination unit 18 calculates an average value of pixels in the partition region determined as including no edge by the edge determination unit 16. When the resulting average value is within a threshold value range for grouping between high-density regions and low-density regions, the region is determined as being a middle tone region. Alternatively, a duty ratio may be used for such a determination. That is, pixels in each of the partition regions may be each set to a dot size based on its pixel value, and when a range of the duty ratio covers 50% for the minimum dot size and 50% for the maximum dot size, the corresponding region is determined as being a middle tone region. This is because the banding problem is most conspicuous in such a range of the duty ratio covering 50% for the minimum dot size and 50% for the maximum dot size.

The first N-value data generation unit 20 serves to generate N-value image data by converting image data into a value N (M>N≧2) by going through a first N-value process, which is an N-value process specifically for middle tone regions. The image data to be converted here is of any partition region determined as being a middle tone region by the middle tone region determination unit 18. The function of the first N-value data generation unit 20 will be described later with a specific example.

The second N-value data generation unit 22 serves to generate N-value image data by converting image data into a value N (M>N≧2) by going through a second N-value process, which is a general N-value process. The image data to be converted here is of any partition region determined as including an edge(s) by the edge determination unit 16, and any partition region determined as not being a middle tone region by the middle tone region determination unit 18, i.e., high-density region and low-density region. The function of the second N-value data generation unit 22 will be described later with a specific example.

By referring to FIG. 7, the right column is an exemplary N-value conversion table 300A, showing the relationship between pixel values and values N (gray level values), and between the values N and dot sizes. Such an N-value conversion table 300A is provided for use of reference at the time of an N-value process taken charge by the first and second N-value data generation units 20 and 22.

The FIG. 7 example shows quarterization of gray level value: N=“4”. Assuming if “brightness value” is selected for a pixel value, and if any acquired multi-value image data is including pixel values of 8-bit, 256 gray levels for the selected brightness, grouping into four N values is possible based on three threshold values of “35”, “110”, and “200”.

More in detail, the brightness value range of “255” to “201” is converted into N-value=“1”, and the brightness value range of “200” to “111”, i.e., first threshold value range, is converted into N-value=“2”. The brightness value range of “110” to “36”, i.e., second threshold value range, is converted into N-value=“3”, and the brightness value range of “35” to “0”, i.e., third threshold value range, is converted into N-value=“4”.

If “density value” is selected for a pixel value, the value ranges are converted into N values in a reverse order.

FIG. 10 shows an exemplary known error diffusion matrix for use specifically for the second N-value process. Together with an error diffusion process using such an error diffusion matrix, the N-value process can reproduce the middle tone with high fidelity.

The printing data generation unit 24 serves to generate printing data in which dots are correspondingly set to values of pixels in the N-value image data, which is generated by the first and second N-value data generation units 20 and 22.

By referring back to FIG. 7, the left column is an exemplary dot size conversion table 300A, in which dots are correspondingly set to values of pixels in the N-value image data, which is generated by the first and second N-value data generation units 20 and 22.

More in detail, in the FIG. 7 example, with N-value=“1”, the dot size to be selected is “no dot”, and with N-value=“2”, selected is “small dot” being smallest in area. With N-value=“3”, selected is “middle dot” being secondly smallest in area, and with N-value=“4”, selected is “large dot” being largest in area. Thus selected dot size is used as a basis for dot setting to pixels.

The printing unit 26 is an ink jet printer with which a predetermined image is formed on a printing medium (paper) S. The image is configured by a plurality of dots of ink ejected from the nozzle modules 50, 52, 54, and 56 provided to the printing head 200. Such dots are formed while either the printing medium or the printing head 200 or both are moved. Together with the printing head 200, the printing unit 26 is configured to include: a printing head feeding mechanism (with a multi-pass printer); a paper feeding mechanism; and a printing control mechanism, all of which are not shown. Specifically, the printing head feeding mechanism reciprocates the printing head 200 in the width direction of the printing medium S, and the paper feeding mechanism moves the printing medium S. The printing control mechanism exercises control over the ink discharge from the printing head 200 based on the printing data.

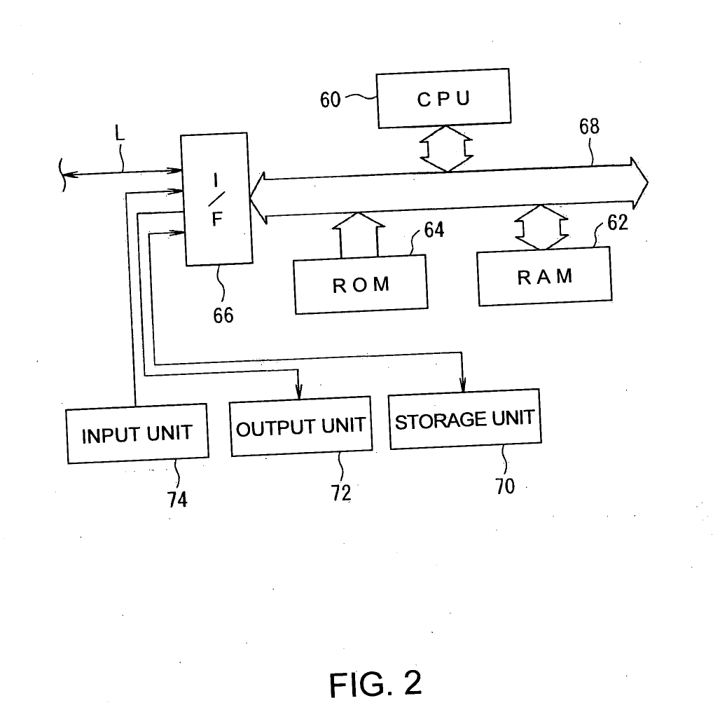

The printing device 100 is provided with a computer system for the purpose of exercising various controls for printing, and implementing on software the component functions of the image data acquisition unit 10, the block partition unit 12, the edge enhancement unit 14, the edge determination unit 16, the middle tone region determination unit 18, the first N-value data generation unit 20, the second N-value data generation unit 22, the printing data generation unit 24, the printing unit 26, and others. As shown in FIG. 2, the computer system has such a hardware configuration that an In/Out bus 68 connects together a CPU (Central Processing Unit) 60, RAM (Random Access Memory) 62, and ROM (Read Only Memory) 64. The In/Out bus 68 varies in type, including PCI (Peripheral Component Interconnect) bus, ISA (Industrial Standard Architecture) bus, or others. Herein, the CPU 60 takes charge of various control applications and computation. The RAM 62 serves as a main storage, and the ROM 64 is a storage device provided specifically for data reading. In the hardware configuration, the In/Out bus 68 is connected with, through an Input/Output interface (I/F) 66, the external storage device 70 (secondary storage) such as HDD (Hard Disk Drive), an output device 72, an input device 74, a network L for communications with a printing command device that is not shown, and others. Herein, the output device 72 is exemplified by the printing unit 22, CRT, LCD monitor, or others, and the input device 74 by an operation panel, mouse, keyboard, scanner, or others.

When the printing device 100 is turned ON, the component functions as described above are implemented on the software by the CPU 60 applying predetermined control and performing computation by putting various resources to full use. For such control application and computation, the CPU 60 follows commands written in programs loaded to the RAM 62. The programs are those loaded by a system program such as BIOS stored in the ROM 64 or others, including various specific computer programs previously stored in the ROM 64 or installed in the storage device 70 via recording media including CD-ROMs, DVD-ROM. flexible disks (FDs), or others, or via a communications network such as the Internet.

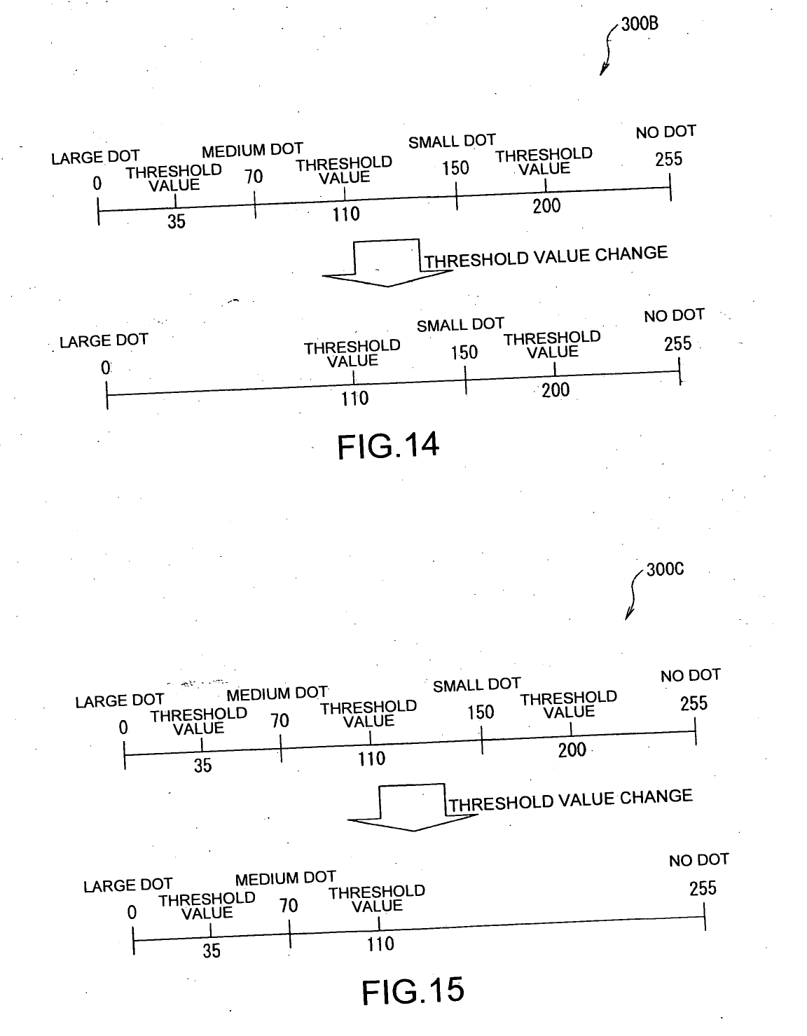

Described next is an exemplary printing process using the printing device 100 of such a configuration by mainly referring to flowcharts of FIG. 8 and FIGS. 11 to 13, and schematic views showing specific process examples of FIGS. 14 to 16.

As described above, the printing head 200 for dot formation is generally so configured as to form dots of various colors, e.g., four or six, substantially at the same time. For the sake of simplification, described below is an exemplary case in which every dot is presumably formed by the printing head 200 using a single color (monochrome color), and the resulting image is a monochrome image.

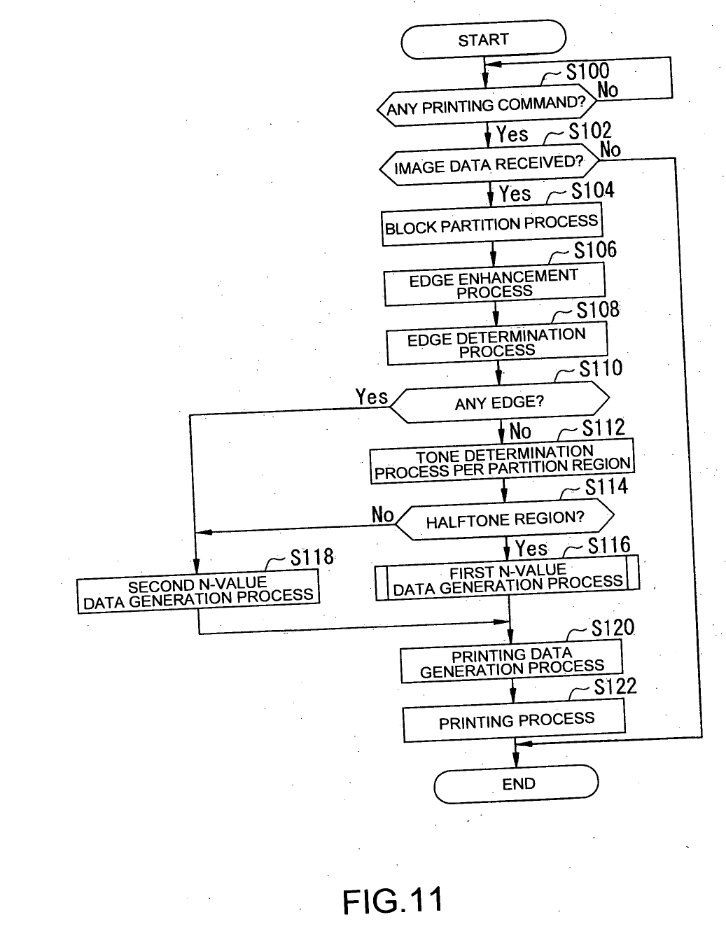

As shown in FIG. 11, exemplified here is a case where the printing device 100 is connected with any printing command terminal such as PC. When the printing device 100 is through with any predetermined initial operation for a printing process after being turned ON, the procedure is started by step S100. In step S100, the image data acquisition unit 10 monitors whether the printing command terminal issues any specific printing command. When the determination is made that a printing command is issued (Yes), the procedure goes to step S102 for another determination whether any target multi-value image data is received together with the printing command.

When the determination is made in step S102 that the target multi-value image data is not provided after the lapse of a predetermined time (No), the procedure is ended. On the other hand, when the determination is made in step S102 that the target image data is received (Yes), the procedure goes to step S104. In step S104, the block partition unit 12 partitions the image data (original image) into a plurality of partition regions, and the procedure then goes to step S106. In step S106, the edge enhancement unit 14 applies an edge enhancement process to all of the resulting partition regions. Note here that the edge enhancement process in step S106 may be applied before step S104, i.e., the region partition process.

After every partition region is through with the edge enhancement process as such, the procedure goes to step S108, and the edge determination unit 16 goes through a process of determining whether there is any edge in the partition regions.

The resulting determination is made in step S110 for each of the partition regions, and to any of the partition regions determined as including an edge(s) (Yes), the second N-value data generation unit 22 applies the second N-value process on a partition region basis in step S118. Here, the second N-value process is a general N-value process. On the other hand, any of the partition regions determined as including no edge (No) is subjected to no process, and the procedure goes to step S112.

In step S112, the middle tone region determination unit 18 applies a gray level determination process to every partition region determined as including no edge. Then in step S114, each of such partition regions is determined whether being of middle tone or not.

As for any partition region determined as not being of middle tone (No), i.e., being a low-density region with no edge or high-density region with no edge, the procedure goes to step S118 for the second N-value process for every partition region similarly to the negative determination (No) in step S110. On the other hand, as for any partition region determined as being of middle tone (Yes), the procedure goes to step S116 for the first N-value process. Herein, the low-density region is with an average density (brightness) being lower than the smallest threshold value, and the high-density region is with an average density (brightness) being higher than the largest threshold value.

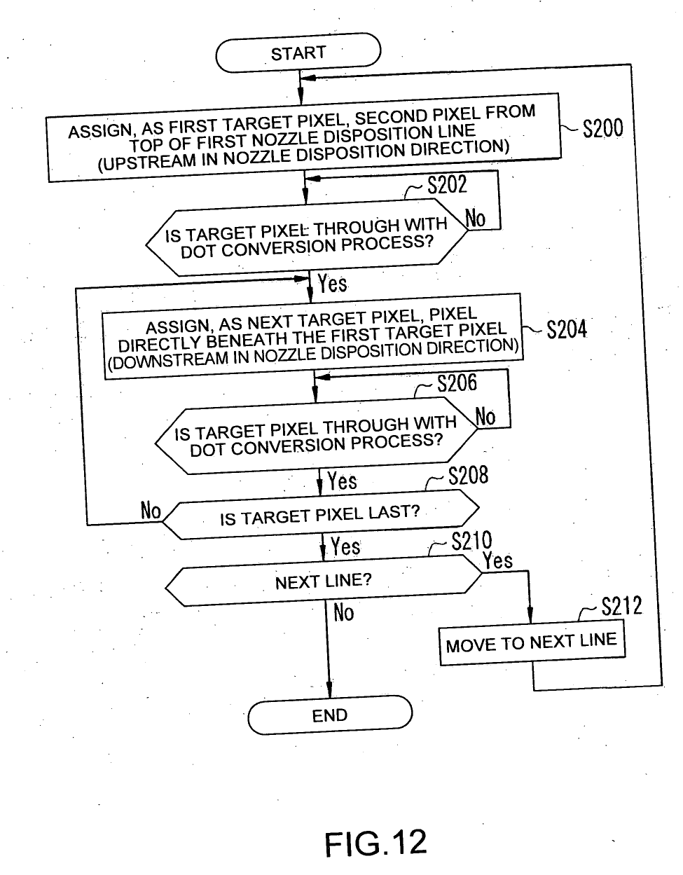

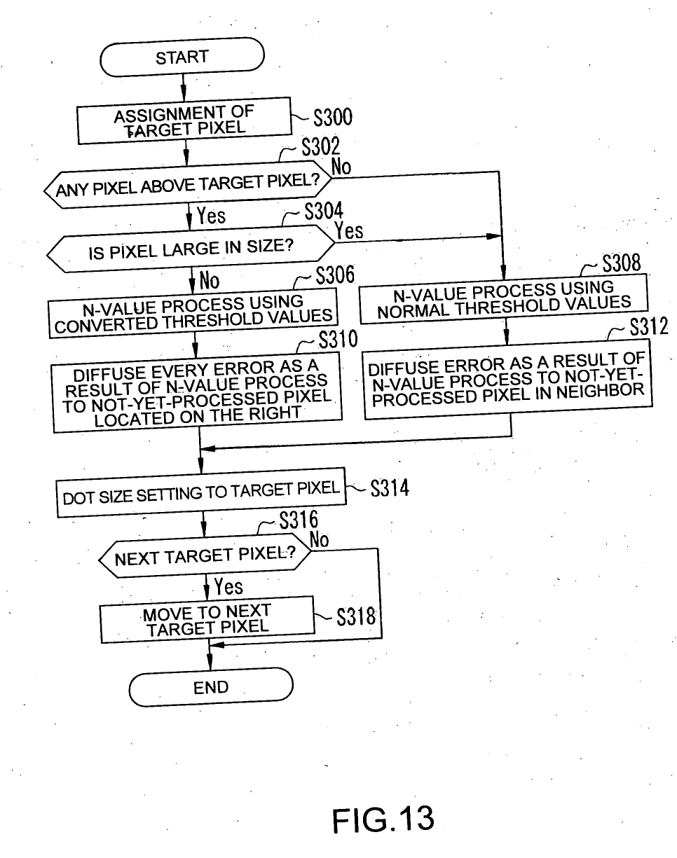

FIG. 12 shows an exemplary flowchart for determining a target pixel for processing in the first N-value data generation process in step S116. FIG. 13 shows an exemplary flowchart of the first N-value data generation process for the determined target pixel.

By referring to FIG. 12, the procedure of determining a target pixel for processing is started by step S200. In step S200, except for a pixel on the top main scanning line in the nozzle disposition direction, the second pixel is determined as a first target pixel. The procedure then goes to step S202, and the target pixel is determined whether or not being through with a dot conversion process. When the determination is made as not yet (No), the procedure stops until the target pixel is through with the process. When the determination is made as Yes, the procedure goes to step S204, and a pixel located directly beneath the target pixel, i.e., downstream in the nozzle disposition direction, is determined as the next target pixel.

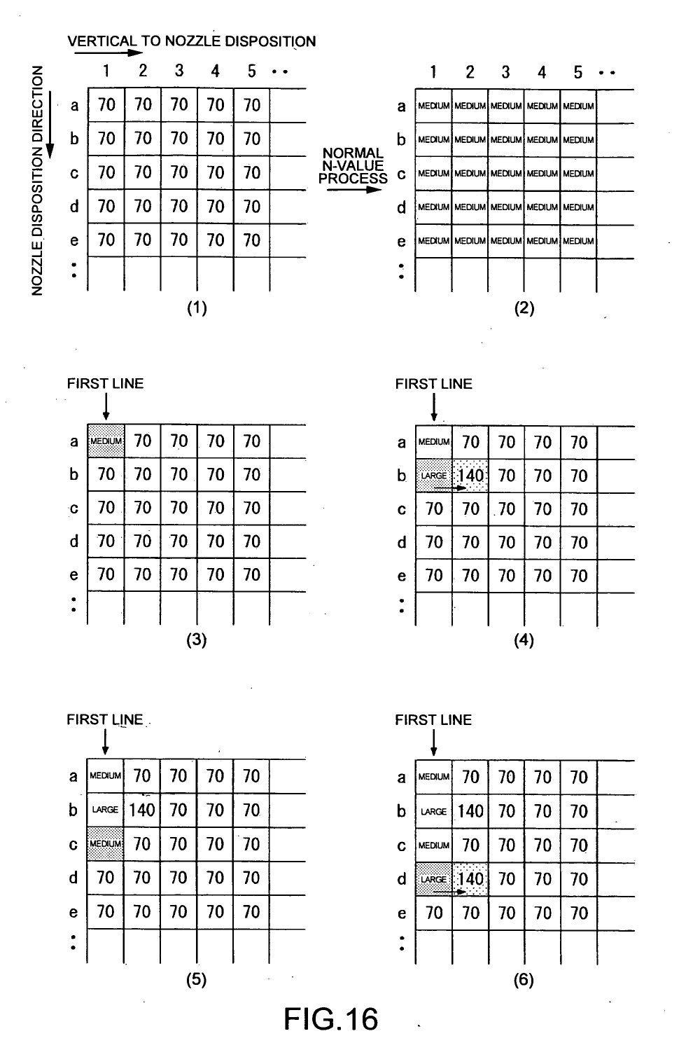

By referring to (1) of FIG. 16, exemplified here is a case with image data including a plurality of pixels in line and column. Assuming that the process is started from a pixel 1a on the upper left, a pixel 1b directly beneath the pixel 1a will be the first target pixel. After the target pixel 1b is through with the process, a pixel 1c directly therebeneath is determined as the next target pixel, and in this manner, pixels located directly beneath the target pixel are sequentially assigned to serve as a target pixel, e.g., 1d, 1e, and others.

The procedure then goes to step S206 for a determination whether the target pixel is through with the process. When the determination is made as Yes, the procedure then goes to step S208 for a determination whether the target pixel is located at the last in the line, i.e., bottom end. When the determination is made as No, the procedure returns to step S204 for the process of sequential pixel assignment for a target pixel. When the target pixel is determined as being located at the last in the line, i.e., bottom end (Yes), the procedure goes to step S210 again.

In step S210, a determination is made whether there is another line after the current line, and when the determination is made as No, the procedure is ended. When the determination is made as Yes, on the other hand, the procedure goes to step S212 for the next line. The procedure then returns to step S200 for subjecting the pixels on the line to the similar process to the above so that the target pixel is to be determined in a sequential manner. Such a process is repeated until the last pixel in the line is subjected thereto.

In the example of (1) of FIG. 16, the first line “1” is subjected to the process on a pixel basis, and once every pixel is through, the next line “2” is started to be subjected to the process. After a pixel 2b second from the top on the line “2” is determined as a target pixel, pixels therebeneath are to be sequentially assigned as a target pixel, i.e., 2c, 2d, 2e, and others. Once every pixel in the line “2” is through, the target pixel assignment moves to the next lines “3”, “4”, and then others. When target pixel assignment is through for a pixel nn located last in the last line “n”, it means that this is the end of the target pixel assignment.

In accordance with the flowchart of FIG. 13, after such target pixel assignment is through for the first target pixel in the multi-value image data for processing in the first step S300, the procedure goes to step S302.

In step S302, a determination is made whether there is any pixel located above the target pixel, i.e., whether the target pixel is located at the top for its line in the nozzle disposition direction. When the target pixel is determined as being at the top for the line (No), the procedure goes to step S308, skipping step S304. When the target pixel is determined as not being at the top for the line (Yes), the procedure goes to step S304.

In step S304, a determination is made whether a pixel located directly above the target pixel is a “large dot” or not. When the pixel is determined as not being a “large dot” (No), the procedure goes to step S306. On the other hand, when the pixel is determined as being a “large dot” (Yes), the procedure goes to step S308.

In step S306, the target pixel is subjected to an N-value process based on special conversion tables 300B and 300C using threshold values different from those of FIGS. 14 and 15. The procedure then goes to step S310, and every error as a result of the N-value process is diffused to a pixel on the right, i.e., a not-yet-processed pixel next thereto in the next line. The procedure then goes to step S314.

In step S308, the N-value process using normal threshold values, i.e., the N-value process using the normal threshold values as shown in FIG. 7, the procedure goes to step S312. In step S312, any error as a result of the N-value process is diffused to not-yet-processed pixels therearound. Such error diffusion is performed in accordance with an error diffusion matrix that is adopted in the normal error diffusion process of FIG. 10. After the error diffusion, the procedure also goes to step S314.

In step S314, the value N determined as such is set to (assigned with) its corresponding dot size, and then the procedure goes to step S316, and then S318 so that every pixel is subjected to the process.

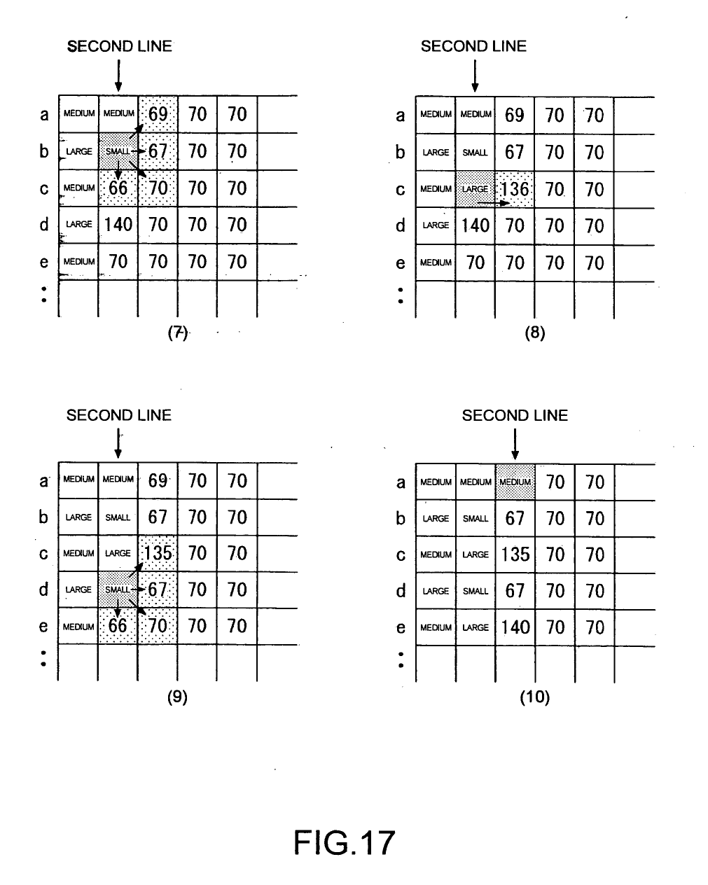

FIGS. 16 and 17 are both a schematic diagram specifically showing an exemplary process procedure on a pixel basis.

As shown in (1) of FIG. 16, when every pixel value (brightness value) in multi-value image data for processing is represented by 8 bits and 256 gray levels, the value is assumed as being “70”.

Such multi-value image data is subjected to an N-value process using normal threshold values based on such a conversion table 300A as shown in FIG. 7, and a dot size corresponding to the resulting value N is determined. As shown in (2) of FIG. 16, the dot size determined for every pixel is “middle dot”.

With such an N-value process using normal threshold values, when the pixel values are all the same or close, the pixels are entirely converted into the same dot size. If with a “small dot”, white or dark streaks will become noticeable if ink deflection occurs to a part of nozzles as shown in FIG. 6 or others. Such white or dark streaks will be more noticeable if those occur in any monotonic partition region of middle tone with no edge, which is to be subjected to the first N-value process.

In view thereof, in the present embodiment, as shown in (3) of FIG. 16, the first target pixel 1a is subjected to an N-value process of steps S300, S302, S308, S312, and S314 based on normal threshold values with the reason that there is no pixel thereabove. The dot size setting is thus made to the resulting value N.

In the example of (3) of FIG. 16, the pixel value of the first target pixel 1a is “70”, and the gray level value: N=“3”, i.e., so-called value “3”. Accordingly, the “middle dot” for the value “3” is correspondingly assigned. Note that no error is produced in this example so that there is no need for an error diffusion process.

After the first target pixel 1a is through with the process as such, as shown in (3) of FIG. 16, the next pixel 1b is assigned as a target pixel, and the pixel 1b is subjected to the process similar to the above.

In this example, although there is another pixel above the target pixel 1b but it is not a “large dot”, and thus the target pixel 1b is subjected to the N-value process using threshold values converted after steps S302 and S306.

That is, the target pixel 1b is “70” in value, and after the N-value process based on normal threshold values, the value will be converted into value “3” so that the “middle dot” is correspondingly assigned thereto. With this being the case, the dot size will be forcefully changed to “large dot” by the N-value table 300B based on the converted threshold values of FIG. 14.

As a result, the target pixel 1b will be “0” in value, thereby producing an error of “70”. As shown in (4) of FIG. 16, the error “70” is entirely diffused to a not-yet-processed pixel located next thereto in the next line, i.e., a pixel 2b. The value of the not-yet-processed pixel 2b is thus converted into “140 (70+70)”.

After the second target pixel 1b is through with the process as such, as shown in (5) of FIG. 16, the next pixel 1c is assigned as a target pixel, and the pixel 1c is subjected to the process similar to the above.

In the example of (5) of FIG. 16, a pixel directly above the target pixel 1c is “large dot”, and thus the target pixel 1c is subjected to the N-value process based on normal threshold values. As a result, the target pixel 1c is converted into “middle dot”.

After the third target pixel 1c is through with the process as such, as shown in (6) of FIG. 16, the next pixel 1d is assigned as a target pixel, and the pixel 1d is subjected to the process similar to the above.

In the example of (6) of FIG. 16, a pixel directly above the target pixel 1d is “medium dot”, and thus the target pixel 1d is subjected to the N-value process based on converted threshold values. As a result, the target pixel 1d is converted into “large dot”, and the resulting error is diffused to the not-yet-processed pixel 2d so that the pixel 2d is changed in value into “140”.

After every pixel in the first line is through with the process, as shown in (7) of FIG. 17, the procedure moves to the next line, i.e., the second line, to subject pixels in the line to the process similar to the above.

In the example of (7) of FIG. 17, the first target pixel 2a in the second line is subjected to the N-value process based on normal threshold values, and as a result, the target pixel 2a is set with “middle dot”. The next target pixel 2b is subjected to the N-value process based on converted threshold values as shown in FIG. 14 after steps S302, S304, and S306 with the reason that a pixel directly thereabove is not a “large dot”.

In the example of (7) of FIG. 17, the target pixel 2b is “140” in value, and even with the N-value process based on converted threshold values of FIG. 14, the resulting value will be value “2” similarly to the case with the N-value process based on normal threshold values. The value “2” is thus set to a “small dot”. The pixel value for the “small dot” is “150”, and there is an error of “−10” compared with the original pixel value. With this being the case, although not shown in the flowchart of FIG. 13, the error of “−10” is diffused into not-yet-processed pixels around the target pixel 2b in accordance with a normal error diffusion matrix as shown in (7) of FIG. 17. This is because there is no difference from the N-value process based on the normal threshold values.

The example of (7) of FIG. 17 is adopting a typical error diffusion matrix called Floyd-Steinberg. As shown in FIG. 10, an error produced as a result of an N-value process is divided into 16 equal value pieces. Out of the resulting 16 value pieces, 7 value pieces are diffused to the not-yet-processed pixel 2c directly beneath the target pixel 2b, 1 value piece is diffused to a not-yet-processed pixel 3c located on the diagonal right down of the target pixel 2b. Also, 5 value pieces are diffused to a not-yet-processed pixel 3b right to the target pixel 2b, and the remaining 3 value pieces are diffused to a not-yet-processed pixel 3a located on the diagonal eight up of the target pixel 2b. As a result of such error diffusion, the not-yet-processed pixel 2c is changed in value from “70” to “66”, and the not-yet-processed pixel 3c is changed in value from “70” to “70 (rounded off)”. The not-yet-processed pixel 3b is changed in value from “70” to “67”, and the not-yet-processed pixel 3a is changed from “70” to “69”.

After the second target pixel 2b is through with the process as such, as shown in (8) of FIG. 17, the pixel 2c directly therebeneath is assigned as a target pixel, and the target pixel 2c is subjected to the process similar to the above.

In the example of (8) of FIG. 17, the target pixel 2c is “66” in value, and is subjected to the N-value process based on the converted threshold values with the reason that the pixel thereabove is not a “large dot”. As a result, the target pixel 2c is converted into a “large dot” as shown in the drawing, and every pixel value of “66” is diffused to the not-yet-processed pixel 3c located next thereto in the next line so that the process is ended.

As shown in (9) of FIG. 17, the procedure moves to the next target pixel 2d for the process similar to the above. The target pixel 2d is subjected to the N-value process based on the normal threshold values with the reason that the pixel 2c directly thereabove is a “large dot”. As a result, the target pixel 2d is converted into a “small dot”, and the resulting error is diffused to not-yet-processed pixels around the target pixel 2d.

After every pixel in the second line is through with the process similar to the above, as shown in (10) of FIG. 17, the procedure moves to the next line, i.e., third line, to subject pixels in the line to the process similar to the above, starting from the pixel 3a at the top.

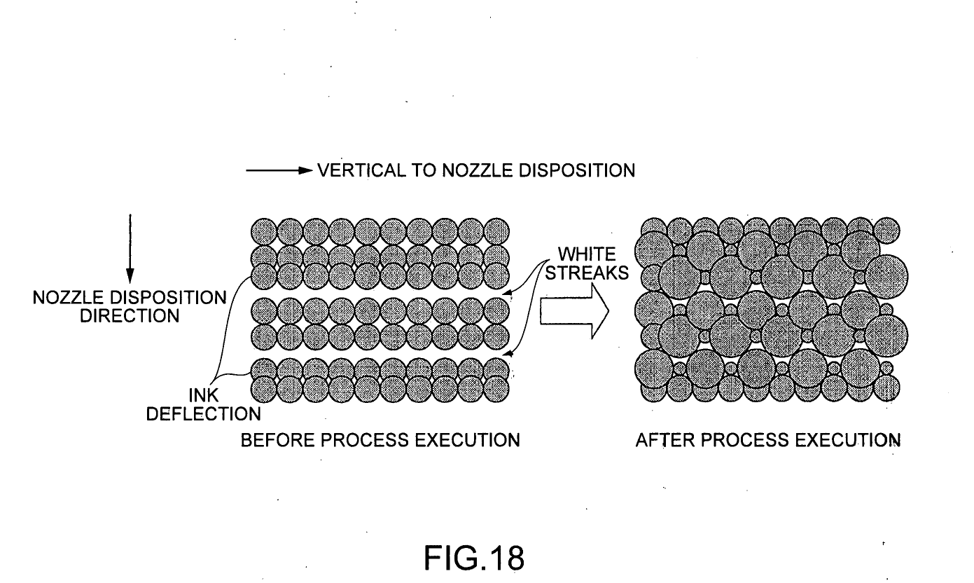

In printing, using the printing data derived as such stops “small or medium dots” appearing in line along the nozzle disposition direction as shown in FIG. 18. This thus can almost perfectly eliminate two white streaks that have been observed between “small or medium dots” before process execution.

What is more, dots in neighbor of “large dots” are “small or medium dots”, and thus “large dots” are not in line vertically or horizontally. This thus prevents the entire image tone from showing a change too much, and the tone can remain almost the same as before.

The above-described technique of changing the dot size in one specific printing object is well-known, often used when the printing result is required to be well-balanced between the printing speed and the printing quality.

More in detail, the image quality can be high with the smaller dot size, and once the dot size is reduced, the mechanical accuracy is required to be high in performance. For forming a solid image with small dots, there needs to form a quite a large number of dots. In consideration thereof, the technique of changing the dot size is specifically applied in such a manner that any highly-detailed image portion is reduced in dot size, and any solid image portion is increased in dot size, thereby favorably implementing a well balance between the printing speed and the image quality.

Such a technique of changing the dot size is easily implemented, when a printing head is provided with a piezo actuator, by exercising control over the discharge amount of ink through voltage change for the piezo actuator.

As such, the first N-value process can favorably avoid occurrence of white streaks resulted from sequential arrangement of dots of a predetermined size or smaller, and successfully keep the original dithering level for any image portion changed in dot size. This is achieved by N-value adjustment, and error diffusion. That is, prior to an N-value process for partition regions of middle tone with no edge, if normally executing the N-value process sequentially arranges dots of a predetermined size or smaller, the N-value is adjusted so not to cause such sequential dot arrangement, and any error produced as a result of such N-value adjustment is diffused to adjacent pixels in the next line.

As such, the error is diffused during the N-value process, thereby eliminating the need for dot size change, favorably increasing the process efficiency.

Exemplified in the present embodiment is the case of using a brightness value for a pixel value. When a density value is a pixel value, an N-value table 300B of FIG. 15 including no “small dot” is used as an N-value table based on converted threshold values.

After the first N-value data generation process is through in step S116 of FIG. 11, the procedure goes to step S120. In step S120, the printing data generation unit 24 synthesizes the partition region through with the first N-value data generation process with the partition region through with the second N-value data generation process. The printing data generation unit 24 also assigns dots of a predetermined size to pixels in the partition region through with the second N-value data generation process in accordance with the conversion table 300A of FIG. 7 so that the image data is entirely generated. The procedure then goes to the last step S122, and prints the image data using the printing unit 22.

As such, in the invention, original image data is partitioned into a plurality of partition regions, and the resulting partition regions are subjected to an edge enhancement process. Thereafter, only any partition region of middle tone density with no edge is subjected to the first N-value process, which is a process for the purpose of reducing a banding problem. The remaining partition region(s) are subjected to the normal N-value process. In such a manner, a banding problem as a result of ink deflection is reduced, and thus white and dark streaks can be eliminated or made less noticeable, whereby the printing result can be increased in quality with efficiency. Such a manner also enables processing appropriate to each of the partition regions so that the printing process can be performed with efficiency.

As shown in FIG. 9, in the present embodiment, pixels with an edge disposed therebetween are varied in density value. Alternatively, either of the pixels may be changed in value. Other than being sequentially changed in value as shown in the drawing, the pixels may be changed in value alternately or randomly as long as the border portion does not appear in streak.

The printing head 200 of the invention, and that of a general type are capable of dealing with four dot formation sizes of “small”, “medium”, “large”, and “no dot” as shown in FIG. 7, This is surely not restrictive, and at least two dot formation sizes plus “no dot” will do. The larger the number of dot formation sizes, the more preferable it is.

In the present embodiment, the printing head 200 corresponds to the printing head provided to the printing device in the first aspect in the summary section. The components of the image data acquisition unit 10, the block partition unit 12, the edge enhancement unit 14, the edge determination unit 16, the middle tone region determination unit 18, the first N-value data generation unit 20, the second N-value data generation unit 22, the printing data generation unit 24, and the printing unit 26 correspond to the components in the printing device of the first aspect or others, i.e., the image data acquisition unit, the block partition unit, the edge enhancement unit, the edge determination unit, the middle tone region determination unit, the first N-value data generation unit, the second N-value data generation unit, the printing data generation unit, and the printing unit.

The invention is characterized as being capable of, without tailoring the existing printing head 200 and the printing unit 26, converting image data into printing data based on the properties of the printing head. This thus eliminates the need to provide any specific device for the printing head 200 and the printing unit 26, and any existing ink jet printing head 200 or printing unit 26 (printer) can be used as it is.

With such a configuration, by separating the printing head 200 and the printing unit 26 from the printing devices 100 of the invention, the component functions can be implemented only by any general-purpose information processing device (image processing device) such as PCs.

The components of the printing device 100 of the invention are surely not necessarily housed in a single cabinet. The components may be partially implemented on the side of a PC, e.g., the first N-value data generation unit 20, and the remaining components may be implemented on the side of a printer, e.g., the printing data generation unit 24, and the printing unit 26.

The invention is not only applicable to an ink deflection problem but is also surely applicable to a problem of causing the same phenomenon as the ink deflection of dots to be formed, which results from the nozzles being not at their ideal positions even if the ink discharge direction is perpendicular, i.e., correct.

The invention is also similarly applicable to such a printing failure that no ink comes from any specific nozzle(s) due to ink clogging or others.

The printing device 100 of the invention is applicable not only to line-head ink jet printers but also to multi-pass ink jet printers. With the line-head ink jet printers, even if an ink deflection problem is observed, the printing result can be derived by a single pass with the high quality of white or dark streaks hardly noticeable. With the multi-pass ink jet printers, the frequency of the reciprocating operation can be reduced so that the higher-speed printing can be achieved. For example, when a single printing operation can lead to any predetermined image quality, compared with the case of printing with reciprocating movements for K number of times, the printing time can be reduced to 1/K.

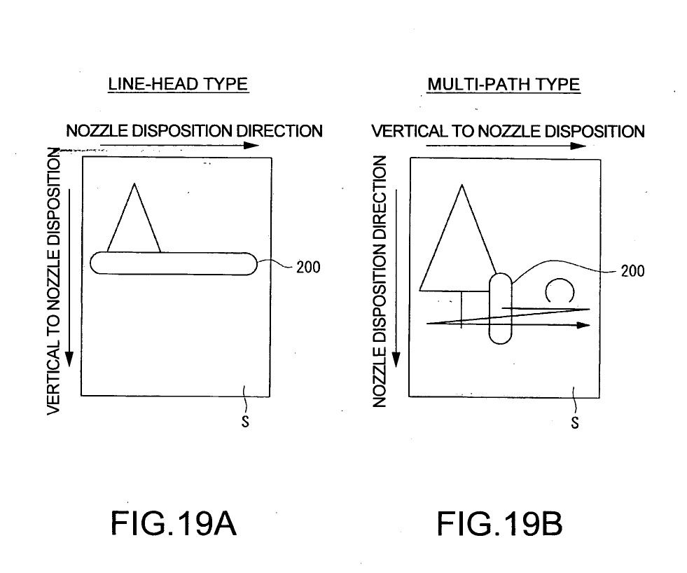

FIGS. 19A and 19B are both diagrams illustrating a printing scheme of a line-head ink jet printer, and that of a multi-pass ink jet printer.

As shown in FIG. 19A, it is assumed that the width direction of a rectangular printing paper P is the nozzle disposition direction of image data, and the longitudinal direction thereof is vertical direction with respect to the nozzle disposition direction of the image data. The line-head ink jet printer is provided with the printing head 200 having the width of the printing paper S. The printing head 200 is fixed, and the printing paper S is moved with respect to the printing head 200 in the vertical direction to the nozzle disposition direction so that the printing can be completed with a single pass, i.e., a single operation. Alternatively, as a so-called flat-head scanner, the printing paper S may be fixed, and the printing head 200 may be moved in the vertical direction to the nozzle disposition direction. Still alternatively, both the printing paper and the printing head may be moved in each opposite direction for printing. On the other hand, as shown in FIG. 19B, the multi-pass ink jet printer is provided with the printer head 200 being rather short in width compared with the paper width. Such a printing head 200 is positioned in the direction orthogonal to the nozzle disposition direction, and is frequently reciprocated in the nozzle disposition direction so that the printing paper S is moved in the vertical direction to the nozzle disposition direction by a predetermined pitch for printing. As such, although the multi-pass ink jet printer has a drawback of taking longer printing time compared with the line-head ink jet printer, it also has an advantage of correcting the above-described banding problem, specifically white streaks, to some extent due to its configuration of possibly placing the printing head 200 at any arbitrary position.

Exemplified in the above embodiment is an ink jet printer that performs printing by discharging ink in dots. This is not restrictive, and the invention is surely applicable to other types of printing devices using a printing head provided with printing mechanisms in a line, or thermal head printers called thermal transfer printers, thermal printers, and the like.

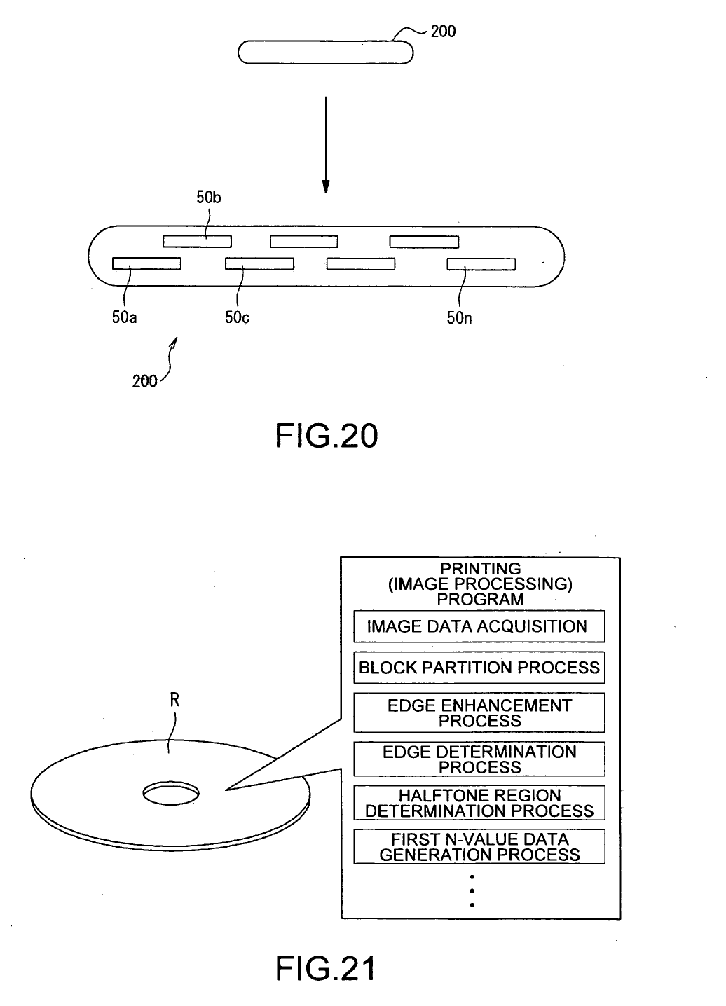

FIG. 3 shows the printing head 200 including the nozzle modules 50, 52, 54, and 56, discharging their corresponding color, and the nozzle modules each carry nozzles N in a line in the longitudinal direction of the printing head 200. As shown in FIG. 20, alternatively, the nozzle modules 50, 52, 54, and 56 may be configured by a plurality of short-length nozzle units 50a, 50b, . . . 50n, those of which are arranged in the movement direction of the printing head 200. Especially if the nozzle modules 50, 52, 54, and 56 are each configured by such short-length nozzle units 50a, 50b, . . . 50n, any long-length nozzle module can be configured by using such short-length nozzle units 50a, 50b, . . . , 50n. This favorably leads to a higher manufacturing yield for the nozzle modules.

The component units provided for implementing the above-described printing device 100 of the invention can be implemented on software using a computer system that is incorporated in most existing printing devices. Product installation of a computer program is made in advance by storage into semiconductor ROM, or the program may be distributed over a network such as the Internet. Alternatively, as shown in FIG. 21, it is possible to enable easy provision for users of the program via a computer-readable recording medium R such as CD-ROMs, DVD-ROMs, and FDs.

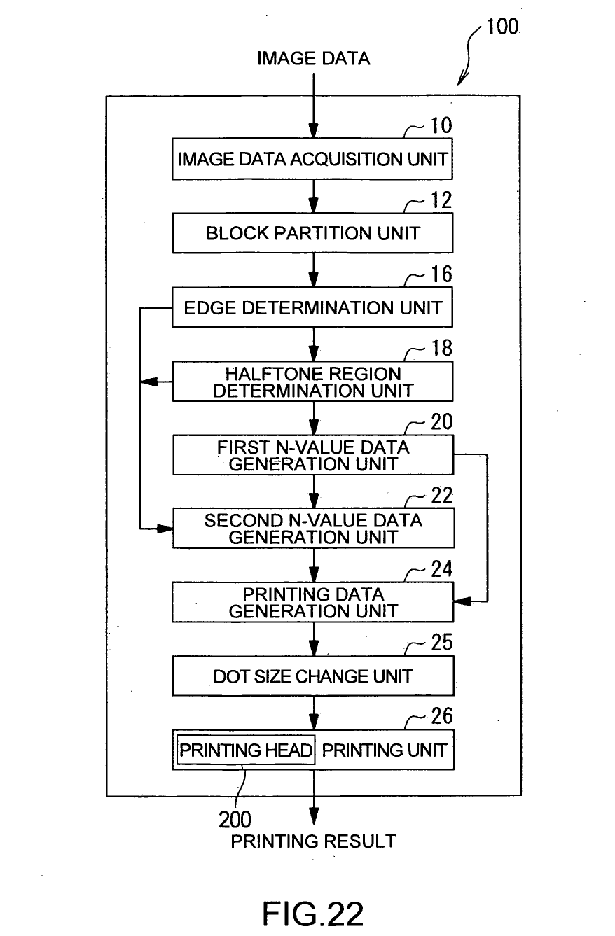

FIG. 22 to 24 are all diagrams showing a second embodiment of the invention, i.e., the printing device 100, a printing program, a printing method, an image processing device, an image processing program, and an image processing method.

First of all, FIG. 22 is a function block diagram of the printing device 100 in the second embodiment of the invention.

As shown in the drawing, almost similar to the first embodiment, the printing device 100 is configured to include, mainly, the printing head 200 provided with a plurality of nozzles, the image data acquisition unit 10, the block partition unit 12, the edge determination unit 16, the middle tone region determination unit 18, the first N-value data generation unit 20, the second N-value data generation unit 22, the printing data generation unit 24, a dot size change unit 25, and the printing unit 26. Specifically, the image data acquisition unit 10 acquires multi-value (M-value (M≧3)) image data for use for printing, and thus acquired image data is partitioned into a plurality of partition regions by the block partition unit 12. The edge determination unit 16 determines whether the partition regions as a result of partition by the block partition unit 12 include therein any edge. The partition region determined as including no edge by the edge determination unit is determined whether as being a middle tone region or not by the middle tone region determination unit 18. As to the partition region determined as being a middle tone region by the middle tone region determination unit 18, the image data therein is converted by the first N-value data generation unit 20 into a value N (M>N≧2) by a first N-value process so that N-value image data is generated. The image data in the partition region determined as including an edge(s) by the edge determination unit 16, or the image data in the partition region determined as not being a middle tone region by the middle tone region determination unit 18 is converted by the second N-value data generation unit 22 into a value N (M>N≧2) by a second N-value process so that N-value image data is generated. The printing data generation unit 24 generates printing data in which dots are correspondingly set to values of pixels in the N-value image data, which is generated by the first and second N-value data generation units 20 and 22. The printing unit 26 is an ink jet type, performing printing based on the printing data in which the dot size is changed by the dot size change unit 25, and the printing data generated by the printing data generation unit 24.

The basic component functions of the second embodiment, i.e., the printing head 200, the image data acquisition unit 10, the block partition unit 12, the edge determination unit 16, the middle tone region determination unit 18, the first N-value data generation unit 20, the second N-value data generation unit 22, the printing data generation unit 24, and the printing unit 26 are similarly to the printing device 100 of the first embodiment. Therefore, such components are not described again, and the dot size change unit 25 will be mainly described.

The dot size change unit 25 in the second embodiment serves to change the size of dots located in edge portions of the printing data generated by the printing data generation unit 24, and enhance the edge. Here, the printing data is specifically the one corresponding to the N-value image data generated by the second N-value data generation unit 22.

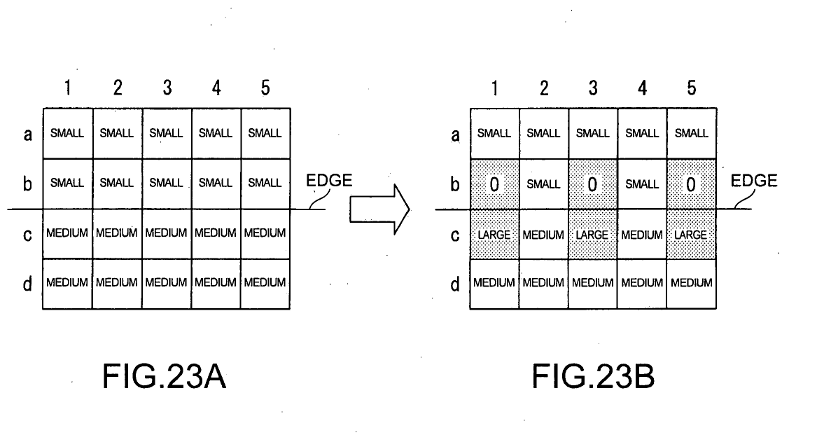

FIGS. 23A and 23B are both schematic diagrams showing an exemplary dot size change process in the dot size change unit 25. Specifically, FIG. 23A is showing an edge portion before the dot size change process, and FIG. 23B is showing the edge portion through with the dot size change process. Therein, the region upper than the edge is higher in density (larger in dot size) compared with the region lower than the edge.

As such, in the dot size change process to be executed by the dot size change unit 25 of the present embodiment, as shown in FIG. 23B, dots located beneath the edge are partially increased in size, and dots located beneath such size-increased dots are reduced in size to a further degree or decimated so that the edged is enhanced.

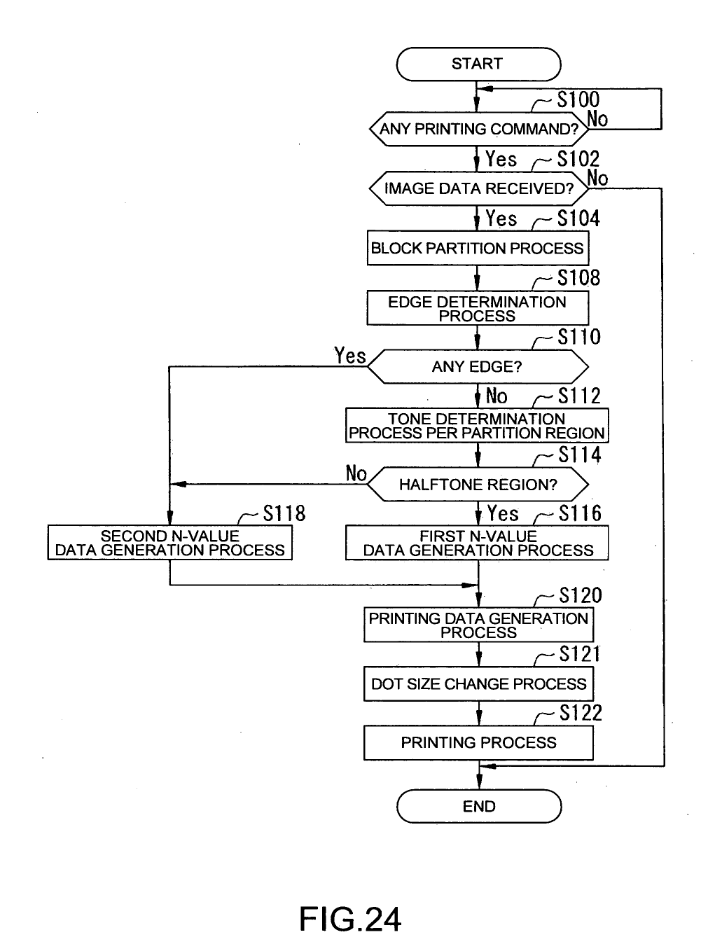

FIG. 24 is a flowchart of an exemplary printing process of the printing device 10 of the present embodiment. The process flow is almost similar to that of the first embodiment except for steps S106 and S121 of FIG. 11.

By referring to the drawing, exemplified here is a case where the printing device 100 is connected with any printing command terminal such as PC. When the printing device 100 is through with any predetermined initial operation for a printing process after being turned ON, the procedure is started by step S100. In step S100, the image data acquisition unit 10 monitors whether the printing command terminal issues any specific printing command. When the determination is made that a printing command is issued (Yes), the procedure goes to step S102 for another determination whether any target multi-value image data is received together with the printing command.

When the determination is made in step S102 that the target multi-value image data is not provided after the lapse of a predetermined time (No), the procedure is ended. On the other hand, when the determination is made in step S102 that the target image data is received (Yes), the procedure goes to step S104. In step S104, the block partition unit 12 partitions the image data (original image) into a plurality of partition regions, and the procedure then goes to step S108 In step S108, the edge determination unit 16 goes through a process of determining whether there is any edge in the partition regions.

The resulting determination is made in step S110 for each of the partition regions, and to any of the partition regions determined as including an edge(s) (Yes), the second N-value data generation unit 22 applies the second N-value process on a partition region basis in step S118. Here, the second N-value process is a general N-value process. On the other hand, any of the partition regions determined as including no edge (No) is subjected to no process, and the procedure goes to step S112.

In step S112, the middle tone region determination unit 18 applies a gray level determination process to every partition region determined as including no edge. Then in step S114, each of such partition regions is determined whether being of middle tone or not.

As for any partition region determined as not being of middle tone (No), i.e., being a low-density region with no edge or high-density region with no edge, the procedure goes to step S118 for the second N-value process similarly to the positive determination (Yes) in step S110. On the other hand, as for any partition region determined as being of middle tone (Yes), the procedure goes to step S116 for the first N-value process. Herein, the low-density region is with an average density (brightness) being lower than the smallest threshold value, and the high-density region is with an average density (brightness) being higher than the largest threshold value.

After the first N-value data generation process in step S116, or after the second N-value data generation process in step S118, the procedure goes to step S120 for synthesis of the respective N-value data. After printing data is generated through dot size assignment in a corresponding manner to the pixel values, the procedure then goes to step S121. In step S121, the dot size change unit 25 executes the process of changing the dot size of edge portions as shown in FIGS. 23A and 23B. The process is executed to printing data corresponding to the N-value data generated by a general N-value process, i.e., printing data corresponding to the N-value data through with the second N-value data generation process in step S118. The procedure then goes to the last step S122, and the printing is performed using the entire printing data including the printing data through with the dot size change process.

That is, in the present embodiment, the dot size change unit 25 is provided as an alternative to the edge enhancement unit 14 of the first embodiment. After the printing data is generated, edge portions of the partition region including an edge(s) are subjected to the dot size change process instead of the edge enhancement process before the N-value process.

With such a configuration, similarly to the first embodiment, a banding problem as a result of ink deflection is favorably reduced so that the resulting printing data can be generated efficiently with high quality with white or dark streaks eliminated or made less noticeable therein. Such a method also enables processing appropriate to each of the partition regions so that the printing process can be performed with efficiency.

As shown in FIGS. 23A and 23B, in the present embodiment, dots with an edge disposed therebetween are changed in size. Alternatively, either of the dots may be changed in size. Other than being alternately or randomly changed in size as shown in the drawing, the dots may be changed in size sequentially along the edge as long as the border portion does not appear in streak.

Similarly to the first embodiment, in the present embodiment, any existing ink jet printing head 200 and the printing unit 26 (printer) can be used as they are.

With such a configuration, by separating the printing head 200 and the printing unit 26 from the configuration of FIG. 22, the component functions can be implemented only by any general-purpose information processing device (image processing device) such as PCs.

The invention is not only applicable to an ink deflection problem but is also surely applicable to a problem of causing the same phenomenon as the ink deflection to dots to be formed, which results from the nozzles being not at their ideal positions even if the ink discharge direction is perpendicular, i.e., correct. The invention is also similarly applicable to such a printing failure that no ink comes from any specific nozzle(s) due to ink clogging or others.

The present embodiment is applicable not only to line-head ink jet printers but also to multi-pass ink jet printers.

In the present embodiment, similarly to the first embodiment, image data is converted into printing data based on the properties of the printing head without tailoring the existing printing head 200 and the printing unit 26. This thus eliminates the need to provide any specific device for the printing head 200 and the printing unit 26, and any existing ink jet printing head 200 or printing unit 26 (printer) can be used as it is.

In the present embodiment, the components of the image data acquisition unit 10, the block partition unit 12, the edge determination unit 16, the middle tone region determination unit 18, the first N-value data generation unit 20, the second N-value data generation unit 22, the printing data generation unit 24, the dot size change unit 25, and the printing unit 26 correspond to the components in the printing device of the first aspect or others, i.e., the image data acquisition unit, the block partition unit, the edge enhancement unit, the edge determination unit, the middle tone region determination unit, the first N-value data generation unit, the second N-value data generation unit, the printing data generation unit, the dot size change unit, and the printing unit.

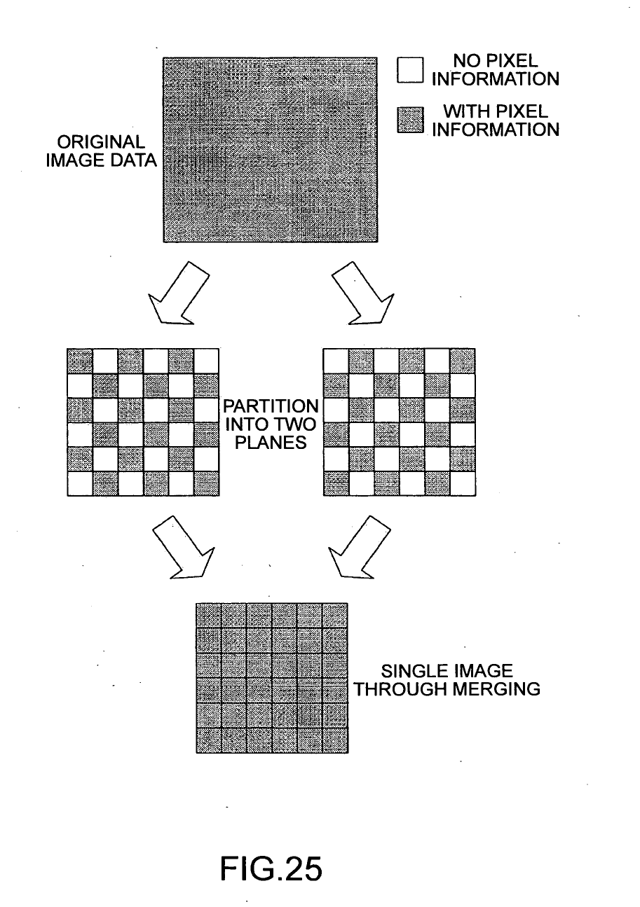

As a third embodiment of the invention, as shown in FIG. 25, original image data for processing is partitioned into two planes or more, and the above-described process is executed to both the planes at the same time. In this manner, the process can be implemented with efficiency.

As a timing for data partition, although not restrictive, other than dividing original image data for processing into two or more planes, the data may be partitioned at the time of the block partition process in step S104 of FIG. 11, at the time of edge determination in step S110, at the time of middle tone determination in step S114, or others.

As a fourth embodiment of the invention, as shown in FIG. 25, original image data for processing is partitioned into two planes, and the above-described processes in the first and second embodiments are executed to both the planes at the same time. The resulting two pieces of data are then synthesized together, and then collectively subjected to a printing process by the printing unit 26. That is, as shown in FIG. 25, original image data for processing is partitioned into two planes, and one of the planes is subjected to processes up to the printing data generation process by the printing data generation unit 24 in the first embodiment. The other plane is subjected to processes up to the process of generating the printing data through with the dot size change process by the dot size change unit 25 in the second embodiment. The resulting two pieces of data are synthesized together by a printing data synthesis unit that is not shown, and the printing unit 26 singly performs printing based on the resulting printing data.

As such, in addition to the effects achieved by the first and second embodiments, the blocks can be subjected to the processes at the same time so that the entire printing process can be increased in efficiency. What is more, the periodicity becomes less apparent to a further degree than only with the first or second embodiment so that the printing result can be high in quality.

Although not restrictive, the processes to be executed to partition regions may be combined variously. For example, a partition region located on the upper left may be subjected to the processes of the first embodiment, and its right partition region may be subjected to the processes of the second embodiment. Such process execution may be performed alternately or every other two partition regions, for example.

The ninth aspect in the summary section corresponds to the fourth embodiment. That is, the image data acquisition unit and the block partition unit of the ninth aspect correspond to the image data acquisition unit 10 and the block partition unit 12 of FIG. 1, 22, or others. The components of the edge enhancement unit, the first edge determination unit, the first middle tone region determination unit, the first N-value data generation unit, the second N-value data generation unit, and the first printing data generation unit correspond to the components of FIG. 1 or others, i.e., the edge enhancement unit 14, the edge determination unit 16, the middle tone region determination unit 18, the first N-value data generation unit 20, the second N-value data generation unit 22, and the printing data generation unit 24.

Moreover, the components of the ninth aspect, i.e., the second edge determination unit, the second middle tone region determination unit, the third N-value data generation unit, the fourth N-value data generation unit, the second printing data generation unit, and the dot size change unit correspond to the components of FIG. 22 or others, i.e., the edge determination unit 16, the middle tone region determination unit 18, the first N-value data generation unit 20, the second N-value data generation unit 22, the printing data generation unit 24, and the dot size change unit 25. The printing unit of the ninth aspect corresponds to the printing unit 26 of FIG. 1, 22, or others.

What is claimed is:

1. A printing device, comprising:
a block partition unit that partitions image data of a value M (M≧3) into a plurality of partition regions;
an edge detection unit that detects an edge in the M-value image data;
an edge enhancement unit that enhances the edge detected by the edge detection unit;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit; and
a printing unit that performs printing based on the printing data generated by the printing data generation unit.

2. The printing device according to claim 1, wherein
the edge enhancement unit reduces a pixel value of any of the pixels located at a portion of the edge.

3. The printing device according to claim 1, wherein
the edge enhancement unit increases a pixel value of any of the pixels located at a portion of the edge.

4. The printing device according to claim 1, wherein
at least one of the edge enhancement unit, the edge determination unit, the middle tone region determination unit, and the printing data generation unit is plurally provided.

5. A printing device, comprising:
a block partition unit that partitions image data of a value M (M≧3) into a plurality of partition regions;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit;
a dot size change unit that changes a size of any of the dots located at a portion of the edge in the printing data that is generated by the printing data generation unit and corresponds to the N-value image data generated by the second N-value data generation unit, and enhances the edge; and
a printing unit that performs printing based on the printing data in which a dot size change is performed by the dot size change unit, and the printing data generated by the printing data generation unit.

6. The printing device according to claim 5, wherein
the dot size change unit reduces the size of any of the dots located at the portion of the edge.

7. The printing device according to claim 5, wherein
the dot size change unit increases the size of any of the dots located at the portion of the edge.

8. The printing device according to claim 5, wherein
at least one of the edge determination unit, the middle tone region determination unit, the printing data generation unit, and the dot size change unit is plurally provided.

9. A printing device, comprising:
a block partition unit that partitions image data of a value M (M≧3) into a plurality of partition regions;
an edge detection unit that detects an edge partially in any of the partition regions as a result of partition by the block partition unit;
an edge enhancement unit that enhances the edge detected by the edge detection unit;
a first edge determination unit that determines whether the partition region edge-enhanced by the edge enhancement unit includes an edge;
a first middle tone region determination unit that determines whether the partition region determined as not including the edge by the first edge determination unit is a middle tone region;
a first N-value data generation unit that generates N-value image data by converting, into a value N (M>N≧2) by going through a first N-value process, the image data of the partition region determined as being the middle tone region by the first middle tone region determination unit;
a second N-value data generation unit that generates the N-value image data by converting, into the value N by going through a second N-value process, the image data of the partition region determined as including the edge by the first edge determination unit, or the image data of the partition region determined as not being the middle tone region by the first middle tone region determination unit; and
a first printing data generation unit that generates printing data in which a dot setting is correspondingly made to pixels of the N-value image data generated by the first N-value data generation unit, and pixels of the N-value image data generated by the second N-value data generation unit, and includes:
a second edge determination unit that determines whether the partition regions as a result of partition by the block partition unit except for the partition regions through with detection by the edge detection unit include the edge;
a second middle tone region determination unit that determines whether the partition region determined as not including the edge by the second edge determination unit is the middle tone region;
a third N-value data generation unit that generates the N-value image data by converting, into the value N by going through the first N-value process, the image data of the partition region determined as being the middle tone region by the second middle tone region determination unit;
a fourth N-value data generation unit that generates the N-value image data by converting, into the value N by going through the second N-value process, the image data of the partition region determined as including the edge by the second edge determination unit, or the image data of the partition region determined as not being the middle tone region by the second middle tone region determination unit;
a second printing data generation unit that generates printing data in which a dot setting is correspondingly made to pixels in the N-value image data generated by the third N-value data generation unit, and pixels in the N-value image data generated by the fourth N-value data generation unit;
a dot size change unit that changes a size of any of the dots located at a portion of the edge in the printing data that is generated by the second printing data generation unit and corresponds to the N-value image data generated by the fourth N-value data generation unit, and enhances the edge;
a printing data synthesis unit that synthesizes together the printing data in which a dot size change is performed by the dot size change unit, the printing data generated by the second printing data generation unit, and the printing data generated by the first printing data generation unit; and
a printing unit that performs printing based on the printing data as a result of data synthesis by the printing data synthesis unit.

10. A printing program embodied on a computer readable medium for use with a computer operable as:
a block partition unit that partitions image data of a value M (M≧3) into a plurality of partition regions;
an edge detection unit that detects an edge in the M-value image data;
an edge enhancement unit that enhances the edge detected by the edge detection unit;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit; and
a printing unit that performs printing based on the printing data generated by the printing data generation unit.

11. A printing program embodied on a computer readable medium for use with a computer operable as:
a block partition unit that partitions image data of a value M (M≧3) into a plurality of partition regions;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit;
a dot size change unit that changes a size of any of the dots located at a portion of the edge in the printing data that is generated by the printing data generation unit and corresponds to the N-value image data generated by the second N-value data generation unit, and enhances the edge; and
a printing unit that performs printing based on the printing data in which a dot size change is performed by the dot size change unit, and the printing data generated by the printing data generation unit.

12. A computer-readable recording medium that is recorded with the printing program of claim 10.

13. A printing method, comprising:
a block partition step of partitioning image data of a value M (M≧3) into a plurality of partition regions;
an edge detection step of detecting an edge in the M-value image data;
an edge enhancement step of enhancing the edge detected by the edge detection step;
an edge determination step of determining whether each of the partition regions as a result of partition by the block partition step includes an edge;
a middle tone region determination step of determining whether the partition region determined as not including the edge by the edge determination step is a middle tone region;
a first N-value data generation step of generating N-value image data by converting, into a value N (M>N≧2) by going through a first N-value process, the image data of the partition region determined as being the middle tone region by the middle tone region determination step;
a second N-value data generation step of generating the N-value image data by converting, into the value N by going through a second N-value process, the image data of the partition region determined as including the edge by the edge determination step, or the image data of the partition region determined as not being the middle tone region by the middle tone region determination step;
a printing data generation step of generating printing data in which a dot setting is correspondingly made to pixels of the N-value image data generated by the second N-value data generation step, and pixels of the N-value image data generated by the first N-value data generation step; and
a printing step of performing printing based on the printing data generated by the printing data generation step.

14. A printing method, comprising:
a block partition step of partitioning image data of a value M (M≧3) into a plurality of partition regions;
an edge determination step of determining whether each of the partition regions as a result of partition by the block partition step includes an edge;
a middle tone region determination step of determining whether the partition region determined as not including the edge by the edge determination step is a middle tone region;
a first N-value data generation step of generating N-value image data by converting, into a value N (M>N≧2) by going through a first N-value process, the image data of the partition region determined as being the middle tone region by the middle tone region determination step;
a second N-value data generation step of generating the N-value image data by converting, into the value N by going through a second N-value process, the image data of the partition region determined as including the edge by the edge determination step, or the image data of the partition region determined as not being the middle tone region by the middle tone region determination step;
a printing data generation step of generating printing data in which a dot setting is correspondingly made to pixels of the N-value image data generated by the second N-value data generation step, and pixels of the N-value image data generated by the first N-value data generation step;
a dot size change step of changing a size of any of the dots located at a portion of the edge in the printing data that is generated by the printing data generation step and corresponds to the N-value image data generated by the first N-value data generation step, and enhancing the edge; and
a printing step of performing printing based on the printing data in which a dot size change is performed by the dot size change step, and the printing data generated by the printing data generation step.

15. An image processing device, comprising:
a block partition unit that partitions image data of a value M (M≧3) into a plurality of partition regions;
an edge detection unit that detects an edge in the M-value image data;
an edge enhancement unit that enhances the edge detected by the edge detection unit;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; and
a printing data generation unit that generates printing data in which a dot setting is correspondingly made to pixels of the N-value image data generated by the first N-value data generation unit, and pixels of the N-value image data generated by the second N-value data generation unit.

16. An image processing device, comprising:
a block partition unit that partitions image data of a value M (M≧3) into a plurality of partition regions;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit; and
a dot size change unit that changes a size of any of the dots located at a portion of the edge in the printing data that is generated by the printing data generation unit and corresponds to the N-value image data generated by the second N-value data generation unit, and enhances the edge.

17. An image processing program embodied on a computer readable medium for use with a computer operable as:
a block partition unit that partitions image data of a value M (M≧3) into a plurality of partition regions;
an edge detection unit that detects an edge in the M-value image data;
an edge enhancement unit that enhances the edge detected by the edge detection unit;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit; and
a printing data generation unit that generates printing data in which a dot setting is correspondingly made to pixels of the N-value image data generated by the first N-value data generation unit, and pixels of the N-value image data generated by the second N-value data generation unit.

18. An image processing program embodied on a computer readable medium for use with a computer operable as:
a block partition unit that partitions image data of a value M (M≧3) into a plurality of partition regions;
an edge determination unit that determines whether each of the partition regions as a result of partition by the block partition unit includes an edge;
a middle tone region determination unit that determines whether the partition region determined as not including the edge by the edge determination unit is a middle tone region;
a first N-value data generation unit that generates N-value image data by converting, into a value N (M>N≧2) by going through a first N-value process, the image data of the partition region determined as being the middle tone region by the middle tone region determination unit;
a second N-value data generation unit that generates the N-value image data by converting, into the value N by going through a second N-value process, the image data of the partition region determined as including the edge by the edge determination unit, or the image data of the partition region determined as not being the middle tone region by the middle tone region determination unit;
a printing data generation unit that generates printing data in which a dot setting is correspondingly made to pixels of the N-value image data generated by the first N-value data generation unit, and pixels of the N-value image data generated by the second N-value data generation unit; and
a dot size change unit that changes a size of any of the dots located at a portion of the edge in the printing data that is generated by the printing data generation unit and corresponds to the N-value image data generated by the second N-value data generation unit, and enhances the edge.

19. A computer-readable recording medium that is recorded with the image processing program of claim 17.

20. An image processing method, comprising:
a block partition step of partitioning image data of a value M (M≧3) into a plurality of partition regions;
an edge detection step of detecting an edge in the M-value image data;
an edge enhancement step of enhancing the edge detected by the edge detection step;
an edge determination step of determining whether each of the partition regions as a result of partition by the block partition step includes an edge;
a middle tone region determination step of determining whether the partition region determined as not including the edge by the edge determination step is a middle tone region;
a first N-value data generation step of generating N-value image data by converting, into a value N (M>N≧2) by going through a first N-value process, the image data of the partition region determined as being the middle tone region by the middle tone region determination step;
a second N-value data generation step of generating the N-value image data by converting, into the value N by going through a second N-value process, the image data of the partition region determined as including the edge by the edge determination step, or the image data of the partition region determined as not being the middle tone region by the middle tone region determination step; and
a printing data generation step of generating printing data in which a dot setting is correspondingly made to pixels of the N-value image data generated by the second N-value data generation step, and pixels of the N-value image data generated by the first N-value data generation step.

21. An image processing method, comprising:
a block partition step of partitioning image data of a value M (M≧3) into a plurality of partition regions;
an edge determination step of determining whether each of the partition regions as a result of partition by the block partition step includes an edge;
a middle tone region determination step of determining whether the partition region determined as not including the edge by the edge determination step is a middle tone region;
a first N-value data generation step of generating N-value image data by converting, into a value N (M>N≧2) by going through a first N-value process, the image data of the partition region determined as being the middle tone region by the middle tone region determination step;
a second N-value data generation step of generating the N-value image data by converting, into the value N by going through a second N-value process, the image data of the partition region determined as including the edge by the edge determination step, or the image data of the partition region determined as not being the middle tone region by the middle tone region determination step;
a printing data generation step of generating printing data in which a dot setting is correspondingly made to pixels of the N-value image data generated by the second N-value data generation step, and pixels of the N-value image data generated by the first N-value data generation step; and
a dot size change step of changing a size of any of the dots located at a portion of the edge in the printing data that is generated by the printing data generation step and corresponds to the N-value image data generated by the first N-value data generation step, and enhancing the edge.
